(19) United States
(12) Patent Application Publication
(10) Pub. No.: US 2022/0244433 A1
(43) Pub. Date: Aug. 4, 2022

(54) OPTICAL ELEMENT MADE OF GLASS

(71) Applicant: Docter Optics SE, Neustadt an der Orla (DE)

(72) Inventors: Joachim Robert Gröll, Neustadt an der Orla (DE); Siegfried Reyman, Neustadt an der Orla (DE)

(73) Assignee: Docter Optics SE, Neustadt an der Orla (DE)

(21) Appl. No.: 17/503,811

(22) Filed: Oct. 18, 2021

(30) Foreign Application Priority Data
Oct. 20, 2020 (DE) 102020127638.9

(51) Int. Cl. G02B 3/00; C03C 3/078; F21S 41/141; F21S 41/25

(52) U.S. Cl. CPC G02B 3/0037; F21S 41/25; F21S 41/141; C03C 3/078

(57) ABSTRACT

The disclosure concerns a glass optical element and a method of manufacturing such a glass optical element, wherein the refractive index of the glass is not less than 1.5, wherein the temperature of the glass corresponding to the viscosity log 2 dPas is less than 1600° C., and wherein the HGB value of the glass is not greater than 0.3.

### PRIORITY CLAIM

This application claims the priority of the German patent application DE 10 2020 127 638.9, filed on 20 Oct. 2020, which is expressly incorporated by reference in its entirety.

### FIELD OF THE INVENTION

The invention relates to an optical element made of glass. The invention also relates to a vehicle headlight lens made of glass and to a vehicle headlight comprising a secondary lens made of glass.

### BACKGROUND

The invention relates to an optical element made of glass. It may be provided here that, for producing an optical element made of glass, a portion of glass or a preform made of glass is blank-pressed to form the optical element, for example on both sides. A suitable method for blank-pressing, for example using a lower mold and an upper mold, is shown in FIG. 16. Optical elements of this kind may for example also be optical elements as shown or disclosed in FIGS. 24 to 32 of the German patent application DE 10 2020 115 078 A1 and the corresponding description (incorporated by reference in its entirety) or in FIGS. 22 to 32 of the German patent application DE 10 2020 115 083 A1 and the corresponding description (incorporated by reference in its entirety).

In addition to particular contour accuracy and precise optical properties being required, the desire has developed for molding headlight lenses from borosilicate glass or glass systems similar to borosilicate glass, in order to obtain increased weather resistance and/or hydrolytic resistance (chemical resistance). Standards or evaluations methods for hydrolytic resistance (chemical resistance) are the Hella N67057 standard test and the climatic test/humidity-frost test, for example. High hydrolytic resistance is also classified as type 1, for example. In the light of the requirement for borosilicate-glass headlight lenses having corresponding hydrolytic resistance, it is desired to mold headlight lenses from borosilicate glass or similar glass systems.

### SUMMARY

Proposed are an optical element made of glass, a vehicle headlight lens made of glass, and a vehicle headlight comprising secondary optics made of glass, using a glass as described in the following. In this case, it may for example be provided that, for its production, a blank made of glass or non-borosilicate glass as mentioned or claimed below is heated and/or provided and, after being heated and/or provided, is molded, for example blank-pressed, for example blank-pressed on both sides, between a first mold, for example for molding and/or blank-pressing a first optically active surface of the optical element, and at least one second mold, for example for molding and/or blank-pressing a second optically active surface of the optical element, to form the optical element or the vehicle headlight lens or the secondary optics.

### BRIEF DESCRIPTION OF THE DRAWINGS

FIG. 1 is a schematic view of a device for producing motor-vehicle headlight lenses or lens-like free-forms for motor-vehicle headlights or optical elements made of glass;

FIG. 1A is a schematic view of a device for producing gobs or optical elements made of glass;

FIG. 1B is a schematic view of a device for producing motor-vehicle headlight lenses or lens-like free-forms for motor-vehicle headlights or optical elements made of glass;

FIG. 2A shows an exemplary sequence of a method for producing motor-vehicle headlight lenses or lens-like free-forms for motor-vehicle headlights or optical elements made of glass;

FIG. 2B shows an alternative sequence of a method for producing motor-vehicle headlight lenses or lens-like free-forms for motor-vehicle headlights or optical elements made of glass;

FIG. 3 shows an embodiment of a lance;

FIG. 4 shows another embodiment of a lance;

FIG. 5 shows an exemplary preform before entering a temperature-control apparatus;

FIG. 6 shows an exemplary preform having a reversed temperature gradient after leaving a temperature-control apparatus;

FIG. 7 shows an embodiment of a transport element;

FIG. 8 shows an embodiment of a heating device for a transport element according to FIG. 7;

FIG. 9 shows an embodiment for removing a transport element according to FIG. 7 from a heating station according to FIG. 8;

FIG. 10 shows a headlight lens on a transport element according to FIG. 7;

FIG. 11 shows another embodiment of a transport element;

FIG. 12 is a cross section through the transport element according to FIG. 11;

FIG. 13 is a schematic view of an embodiment of an annealing kiln;

FIG. 14 shows a lance according to FIG. 3 in a hood-type annealing furnace for heating a gob;

FIG. 15 shows an embodiment of a glass batch;

FIG. 16 shows an embodiment of a mold set for blank-pressing;

FIG. 17 is a schematic view of a motor-vehicle headlight (projection headlight) comprising a headlight lens;

FIG. 18 is a bottom view of a headlight lens according to FIG. 17;

FIG. 19 is a cross section through the lens according to FIG. 18;

FIG. 20 is a detail of the view according to FIG. 19;

FIG. 21 shows the detail according to FIG. 20 with a detail of the transport element (in cross section);

FIG. 22 is a schematic view of an embodiment of a vehicle headlight according to FIG. 1;

FIG. 23 shows an embodiment of matrix light or adaptive high beam;

FIG. 24 shows another embodiment of matrix light or adaptive high beam;

FIG. 25 shows an embodiment of an illumination device of a vehicle headlight according to FIG. 22;

FIG. 26 is a side view of an embodiment of a front optics array;

FIG. 27 is a plan view of the front optics array according to FIG. 26 and;

FIG. 28 shows the use of a front optics array according to FIGS. 26 and 27 in a motor-vehicle headlight;

FIG. 29 shows another embodiment of an alternative vehicle headlight;

FIG. 30 shows another embodiment of an alternative vehicle headlight;

FIG. 31 shows an example of the illumination by means of a headlight according to FIG. 30;

FIG. 32 shows an embodiment of superimposed illumination using the illumination according to FIG. 31 and the illumination by two other headlight systems or sub-systems;

FIG. 33 shows an embodiment of an objective lens;

FIG. 34 shows luminous power plotted against the distance from a considered point of an object;

FIG. 35 shows a projection display comprising a microlens array having a curved base surface;

FIG. 36 shows a microlens array comprising a round carrier;

FIG. 37 shows an embodiment, modified compared with the embodiment according to FIG. 14, for heating a preform in a hood-type annealing furnace using a lower mold part and a cooling body;

FIG. 38 shows an embodiment for the transport of a heated preform in a housing for minimizing the cooling of a preform during transport from a hood-type annealing furnace to a pressing station;

FIG. 39 shows an embodiment for pressing a preform using a lower mold, which comprises a first lower mold part and a second lower mold part;

FIG. 40 shows the pressing of an intermediate formed body from a preform by not completely bringing a lower mold and an upper mold towards one another or not completely closing a cavity formed by an upper mold and a lower mold;

FIG. 41 shows an embodiment for heating a side of an intermediate formed body facing a lower mold;

FIG. 42 shows an embodiment for pressing an optical element from an intermediate formed body;

FIG. 43 shows an embodiment for moving a lower mold and an upper mold away from one another for opening a cavity for pressing an optical element;

FIG. 44 shows an embodiment for cooling an optical element in an annealing kiln, wherein the optical element rests on a lower mold part, and

FIG. 45 shows an embodiment of a biconvex lens.

### DETAILED DESCRIPTION

This disclosure relates, for example, to an optical element made of glass, for example a vehicle headlight lens, for example blank-pressed on both sides,
wherein the sum of the alkalis in the glass is no less than 5 wt. %, for example no less than 10 wt. %, for example no less than 11 wt. %, for example no less than 12 wt. %, for example no less than 13 wt. %, and/or
wherein the sum of the alkalis in the glass is no greater than 18 wt. %, for example no greater than 16 wt. %, for example no greater than 15 wt. %, and/or
wherein the glass contains no less than 2 wt. %, for example no less than 2.5 wt. %, for example no less than 2.7 wt. %, for example no less than 3 wt. %, for example no less than 3.3 wt. %, ZnO, and/or
wherein the glass contains no greater than 4 wt. %, for example no greater than 3.95 wt. %, for example no greater than 3.75 wt. %, for example no greater than 3.5 wt. %, ZnO, and/or
wherein the glass contains no less than 1.5 wt. %, for example no less than 2.0 wt. %, for example no less than 2.05 wt. %, for example no less than 2.25 wt. %, Al₂O₃, and/or
wherein the glass contains no greater than 3 wt. %, for example no greater than 2.8 wt. %, for example no greater than 2.6 wt. %, Al₂O₃.

Within the meaning of this disclosure, wt. % means oxide-based weight percent. In another configuration, it is provided that
the sum of the alkalis (or alkali metals) in the glass is no less than 12 wt. %, and
the glass contains no greater than 4 wt. % ZnO, and
the glass contains no greater than 3 wt. % Al₂O₃.

In another configuration, it is provided that the glass contains no greater than 70 wt. % SiO₂.

In another configuration, it is provided that the glass contains
1.5 wt. % to 3 wt. % Al₂O₃ 2 wt. % to 3 wt. % Al₂O₃,
3 wt. % to 4 wt. % BaO or 3.2 wt. % to 3.8 wt. % BaO,
3 to 10 wt. % K₂O,
3 to 10 wt. % Na₂O,
3 to 10 wt. % CaO,
0 to 1.5 wt. % Li₂O or 0.2 wt. % to 1 wt. % Li₂O,
0 to 6 wt. % MgO or 0.1 wt. % to 5 wt. % MgO,
2 to 4 wt. % ZnO, or 3 wt. % to 3.75 wt. % ZnO, and
0 to 1.5 wt. % Sb₂O₃ or 0.3 wt. % to 1.3 wt. % Sb₂O₃.

In another configuration, it is provided that the glass contains
65 wt. % to 75 wt. % SiO₂ or 65 wt. % to 70 wt. % SiO₂,
1.5 wt. % to 3 wt. % Al₂O₃ or 2 wt. % to 3 wt. % Al₂O₃,
3 wt. % to 4 wt. % BaO or 3.2 wt. % to 3.8 wt. % BaO,
3 to 10 wt. % K₂O,
3 to 10 wt. % Na₂O,
3 to 10 wt. % CaO,
0 to 1.5 wt. % Li₂O or 0.2 wt. % to 1 wt. % Li₂O,
0 to 6 wt. % MgO or 0.1 wt. % to 5 wt. % MgO,
2 to 4 wt. % ZnO, or 3 wt. % to 3.75 wt. % ZnO, and
0 to 1.5 wt. % Sb₂O₃ or 0.3 wt. % to 1.3 wt. % Sb₂O₃.

In another configuration, it is provided that
the refractive index of the glass is no less than 1.5, for example no less than 1.52, for example no less than 1.521,
the refractive index of the glass is no greater than 1.524, for example no greater than 1.523,
the temperature of the glass corresponding to the viscosity log 2 dPas is less than 1600° C.,
the HGB value of the glass is no greater than 0.5, for example no greater than 0.4, for example no greater than 0.3, and/or
the HGB value of the glass is no less than 0.02 or no less than 0.05 or no less than 0.1.

Within the meaning of this disclosure, the HGB value means 0.01M HCl consumed to neutralize extracted basic oxides, in ml, according to ISO 719.

In another configuration, it is provided that the glass does not contain any PbO and/or B₂O₃.

Within the meaning of this disclosure, a glass does not contain an element for example if this element is not supplied in a deliberate, intentional or active manner during melting. It may be provided that an element not contained in the glass is nevertheless contained in the glass by way of impurities. Within the meaning of this disclosure, a glass does not contain an element for example if this element is indeed found in the glass, but in such a small quantity that it is functionally inactive or does not have a function or effect (when used as intended).

In another configuration, it is provided that
the refractive index of the glass is no less than 1.5, for example no less than 1.52, for example no less than 1.521,
the refractive index of the glass is no greater than 1.524, for example no greater than 1.523,
the temperature of the glass corresponding to the viscosity log 2 dPas is less than 1600° C.,
the HGB value of the glass is no greater than 0.5, for example no greater than 0.4, for example no greater than 0.3, and
the HGB value of the glass is no less than 0.02 or no less than 0.05 or no less than 0.1.

One configuration also relates to a method for producing an optical element made of glass, for example an optical element made of the above-mentioned glass, in which a blank made of glass is heated and/or provided and, after being heated and/or provided, is blank-pressed, for example on both sides, for example between a first mold and at least one second mold, for example
wherein the sum of the alkalis in the glass is no less than 5 wt. %, for example no less than 10 wt. %, for example no less than 11 wt. %, for example no less than 12 wt. %, for example no less than 13 wt. %, and/or
wherein the sum of the alkalis in the glass is no greater than 18 wt. %, for example no greater than 16 wt. %, for example no greater than 15 wt. %, and/or
wherein the glass contains no less than 2 wt. %, for example no less than 2.5 wt. %, for example no less than 2.7 wt. %, for example no less than 3 wt. %, for example no less than 3.3 wt. %, ZnO, and/or
wherein the glass contains no greater than 4 wt. %, for example no greater than 3.95 wt. %, for example no greater than 3.75 wt. %, for example no greater than 3.5 wt. %, ZnO, and/or
wherein the glass contains no less than 1.5 wt. %, for example no less than 2.0 wt. %, for example no less than 2.05 wt. %, for example no less than 2.25 wt. %, Al₂O₃, and/or
wherein the glass contains no greater than 3 wt. %, for example no greater than 2.8 wt. %, for example no greater than 2.6 wt. %, Al₂O₃.

It may be provided that the first optically active surface and/or the second optically active surface (after pressing) is sprayed with a surface-treatment agent. Within the meaning of this disclosure, spraying for example includes atomizing, misting and/or (the use of) spray mist. Within the meaning of this disclosure, spraying for example means atomizing, misting and/or (the use of) spray mist.

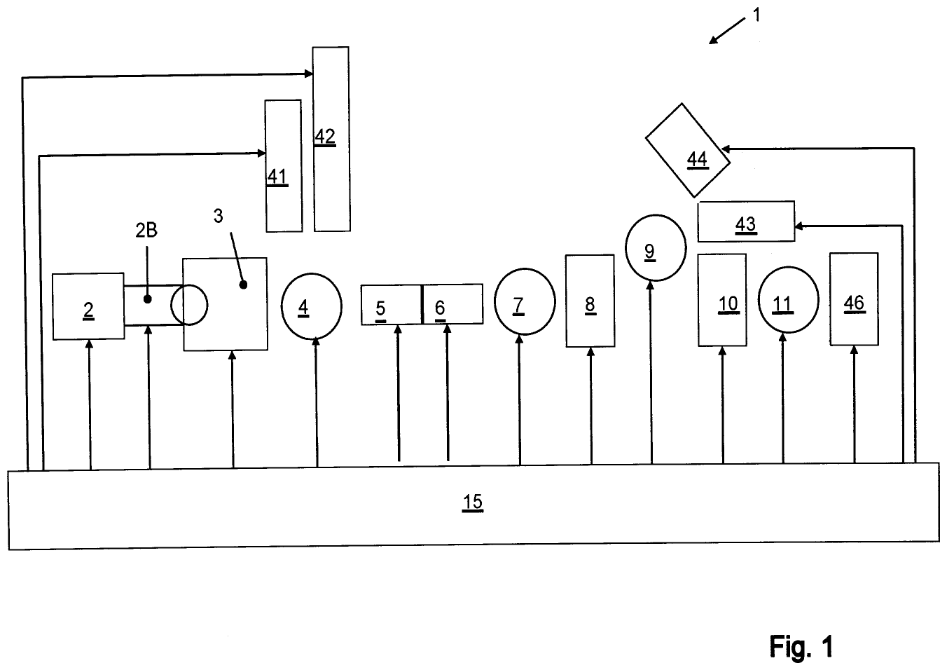

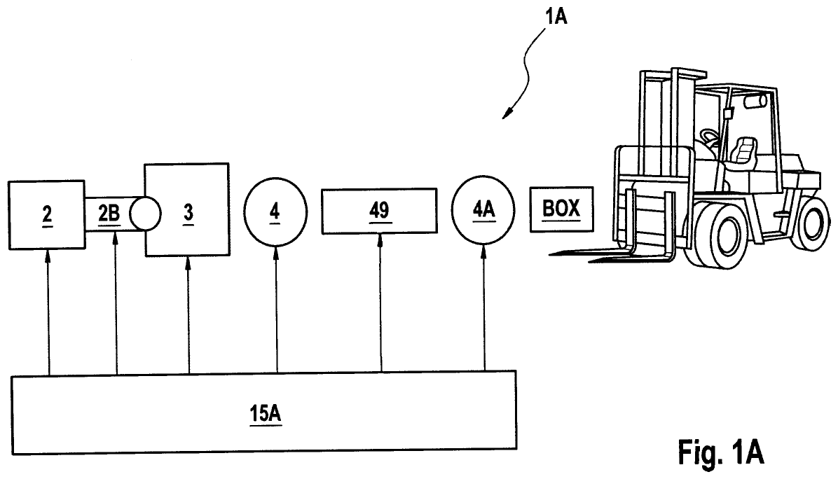

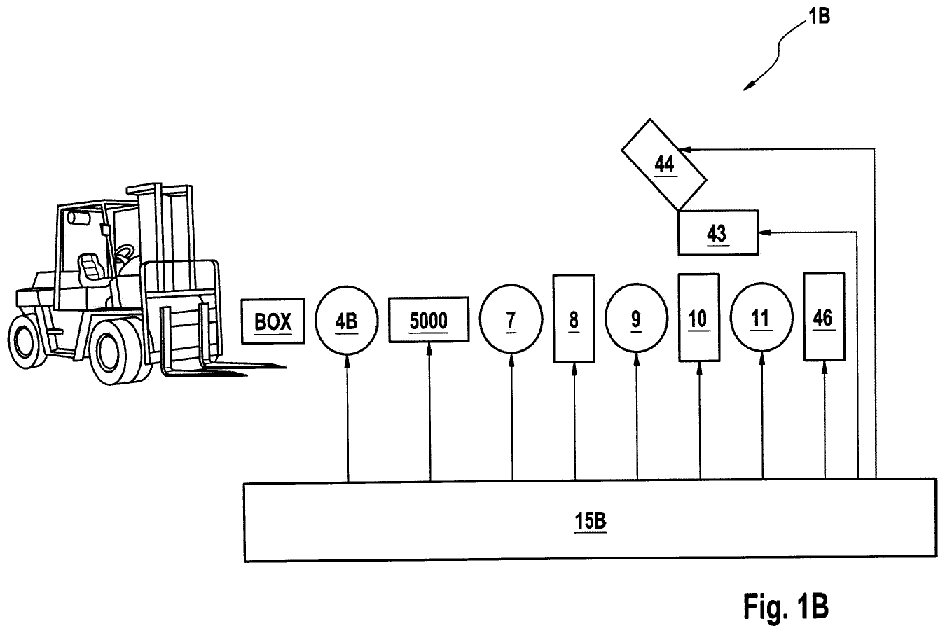

The surface-treatment agent for example contains AlCl3*6H2O (dissolved in a solvent and/or H2O), wherein suitable mixture ratios can be found in DE 103 19 708 A1 (e.g. FIG. 1). At least 0.5 g, for example at least 1 g, AlCl3*6H2O is provided per liter H2O, for example.

In another configuration, the first optically active surface and the second optically active surface are sprayed with the surface-treatment agent at least partially simultaneously (overlapping in time).

In another configuration, the temperature of the optical element and/or the temperature of the first optically active surface and/or the temperature of the second optically active surface during spraying with surface-treatment agent is no less than T_{G} or T_{G}+20 K, wherein T_{G} denotes the glass transition temperature.

In another configuration, the temperature of the optical element and/or the temperature of the first optically active surface and/or the temperature of the second optically active surface during spraying with surface-treatment agent is no greater than T_{G}+100 K.

In another configuration, the surface-treatment agent in the form of a spray agent is sprayed onto the optically active surface, wherein the surface-treatment agent forms droplets, the size of which and/or the average size thereof and/or the diameter thereof and/or the average diameter thereof is no greater than 50 μm.

In another configuration, the surface-treatment agent in the form of a spray agent is sprayed onto the optically active surface, wherein the surface-treatment agent forms droplets, the size of which and/or the average size thereof and/or the diameter thereof and/or the average diameter thereof is no less than 10 μm.

In another configuration, the surface-treatment agent is sprayed so as to be mixed with compressed air. In another configuration, compressed air, for example in combination with a mixing nozzle or dual-substance nozzle, is used for generating a spray mist for the surface-treatment agent.

In another configuration, the optically active surface is sprayed with the surface-treatment agent before the optical element is cooled in an annealing line for cooling in accordance with a cooling regime.

In another configuration, an optically active surface is sprayed with the surface-treatment agent for no longer than 4 seconds. Here, an optically active surface is sprayed with the surface-treatment agent for example for no longer than 12 seconds, for example for no longer than 8 seconds, for example for no less than 2 seconds. In this process, the optically active surface is sprayed until it has been sprayed with no less than 0.05 ml surface-treatment agent and/or with no more than 0.5 ml, for example 0.2 ml, surface-treatment agent.

It is for example provided that, after being sprayed with surface-treatment agent, the headlight lens or a proposed headlight lens consists of at least 90%, for example at least 95%, for example (substantially) 100%, quartz glass on the surface. It is for example provided that the following is applicable in relation to the oxygen bonding to silicon on the surface of the headlight lens or the optical element

$$\frac{Q ( 4 )}{Q ( 4 ) + Q ( 3 )} \geq 0.9$$

for example

$$\frac{Q ( 4 )}{Q ( 4 ) + Q ( 3 )} \geq 0.95$$

In the above, Q(3) and Q(4) denote the crosslinking of the oxygen ions with the silicon ion, for example, wherein 3 oxygen ions (Q(3)) or 4 oxygen ions (Q(4)) are arranged at the tetrahedron corners of the silicon ion. Q(3) for example represents (the quantity of) Q³, i.e. (SiO4)4 or trimmers, and Q(4) for example represents (the quantity of) Q⁴, i.e. (SiO4)5 or tetramers (cf. the article “Silica scale formation and effect of sodium and aluminum ions—Si NMR study” at the web address pdfs.semanticscholar.org/05b0/226cd373c555f59d5d48ef1a8f5ceaece96d.pdf).

The proportion of quartz glass decreases towards the interior of the headlight lens or optical element, wherein, at a depth (distance from the surface) of 5 μm, it is for example provided that the proportion of quartz glass is at least 10%, for example at least 5%. It is for example provided that the following is applicable in relation to the oxygen bonding to silicon of the headlight lens or the optical element at a depth of 5 μm

$$\frac{Q ( 4 )}{Q ( 4 ) + Q ( 3 )} \geq 0.1$$

for example

$$\frac{Q ( 4 )}{Q ( 4 ) + Q ( 3 )} \geq 0.05$$

It is for example provided that the proportion of quartz glass at a depth (distance from the surface) of 5 μm is no greater than 50%, for example no greater than 25%.

It is for example provided that the following is applicable in relation to the oxygen bonding to silicon of the headlight lens or the optical element at a depth of 5 μm

$$\frac{Q ( 4 )}{Q ( 4 ) + Q ( 3 )} \leq 0.5$$

for example

$$\frac{Q ( 4 )}{Q ( 4 ) + Q ( 3 )} \leq 0.25$$

It may be provided that the first mold is moved by means of an actuator for moving the first mold by the first mold and the actuator being connected by means of a first movable guide rod and at least one second movable guide rod, for example at least one third movable guide rod, wherein the first movable guide rod is guided in a (first) recess in a fixed guide element and the second guide rod is guided in a (second) recess in the fixed guide element and the optional third movable guide rod is guided in a (third) recess in the fixed guide element, wherein it is for example provided that the first mold is connected to the first movable guide rod and/or the second movable guide rod and/or the optional third movable guide rod by means of a movable connector, wherein it is for example provided that the deviation in the position of the mold orthogonally to the movement direction of the mold from the target position of the mold orthogonally to the movement direction of the mold is no greater than 20 μm, for example no greater than 15 μm, for example no greater than 10 μm.

One configuration also relates to a method for producing an optical element, wherein a blank made of the above-mentioned glass is heated and/or provided and, after being heated and/or provided, is blank-pressed, for example on both sides, between a first mold and at least one second mold to form the optical element, wherein the at least one second mold is moved by means of an actuator for moving the second mold in a frame, which comprises a first fixed guide rod, at least one second fixed guide rod and for example at least one third guide rod, wherein the first fixed guide rod, the at least one second fixed guide rod and the optional at least one third guide rod are connected at one end by an actuator-side fixed connector and at the other end by a mold-side fixed connector, wherein the at least one second mold is fixed to a movable guide element, which comprises a (first) recess through which the first fixed guide rod is guided, another (second) recess through which the at least one second fixed guide rod is guided, and optionally another (third) recess through which the optional third fixed guide rod is guided, wherein it is for example provided that the deviation in the position of the mold orthogonally to the movement direction of the mold from the target position of the mold orthogonally to the movement direction of the mold is no greater than 20 μm, for example no greater than 15 μm, for example no greater than 10 μm. The at least one second mold may be fixed to the movable guide element by means of a mold receptacle. This can result in a distance between the second mold and the movable guide element. In one configuration, this distance is no greater than 150 mm, for example no greater than 100 mm, for example no greater than 50 mm.

In another configuration, it is for example provided that the first mold is moved by means of an actuator for moving the first mold by the first mold and the actuator for moving the first mold being connected by means of a first movable guide rod and at least one second movable guide rod, for example at least one third movable guide rod, wherein the first movable guide rod is guided in a (first) recess in a fixed guide element and the second guide rod is guided in a (second) recess in the fixed guide element and the optional third movable guide rod is guided in a (third) recess in the fixed guide element, wherein it is for example provided that the first mold is connected to the first movable guide rod and/or the second movable guide rod and/or the optional third movable guide rod by means of a connector.

In another configuration, the blank made of the above-mentioned glass, after being heated and/or provided, is blank-pressed, for example on both sides, between the first mold and the at least one second mold to form the optical element, such that the deviation in the position of the first and/or the second mold orthogonally to the (target) pressing direction or the (target) movement direction of the first and/or the second mold from the target position of the first and/or the second mold orthogonally to the (target) pressing direction or the (target) movement direction of the first and/or the second mold is no greater than 20 μm, for example no greater than 15 μm, for example no greater than 10 μm.

One configuration also relates to a method for producing an optical element, wherein a blank made of the above-mentioned glass is heated and/or provided and, after being heated and/or provided, is blank-pressed, for example on both sides, between a first mold and at least one second mold to form the optical element, such that the deviation in the position of the first and/or the second mold orthogonally to the (target) pressing direction or the (target) movement direction of the first and/or the second mold from the target position of the first and/or the second mold orthogonally to the (target) pressing direction or the (target) movement direction of the first and/or the second mold is no greater than 20 μm, for example no greater than 15 μm, for example no greater than 10 μm.

In another configuration, the blank made of glass, after being heated and/or provided, is blank-pressed, for example on both sides, between the first mold and the at least one second mold to form the optical element, such that a or the angle between the target pressing direction of the first mold and the actual pressing direction of the first mold is no greater than 10⁻²°, for example no greater than 5·10⁻³°.

One configuration also relates to a method for producing an optical element, wherein a blank made of glass, after being heated and/or provided, is blank-pressed, for example on both sides, between the first mold and the at least one second mold to form the optical element, such that a or the angle between the target pressing direction of the first mold and the actual pressing direction of the first mold is no greater than 10⁻²°, for example no greater than 5·10⁻³°.

In another configuration, the blank made of glass, after being heated and/or provided, is blank-pressed, for example on both sides, between the first mold and the at least one second mold to form the optical element, such that a or the angle between the target pressing direction of the second mold and the actual pressing direction of the second mold is no greater than 10⁻²°, for example no greater than 5·10⁻³°.

One configuration also relates to a method for producing an optical element, wherein a blank made of glass, after being heated and/or provided, is blank-pressed, for example on both sides, between the first mold and the at least one second mold to form the optical element, such that a or the angle between the target pressing direction of the second mold and the actual pressing direction of the second mold is no greater than 10⁻²°, for example no greater than 5·10⁻³°.

In another configuration, the blank made of glass, after being heated and/or provided, is blank-pressed, for example on both sides, between the first mold and the at least one second mold to form the optical element, such that the first actuator is decoupled from torsion from the mold-side movable connector and/or the first mold (for example by means of a decoupler, which for example comprises a ring and/or at least one first disc as well as optionally at least one second disc, wherein it may be provided that the ring encompasses the first and/or second disc).

In another configuration, the blank made of glass, after being heated and/or provided, is blank-pressed, for example on both sides, between the first mold and the at least one second mold to form the optical element, such that the second actuator is decoupled from torsion from the mold-side movable guide element and/or the second mold (for example by means of a decoupler, which for example comprises a ring and/or at least one first disc as well as optionally at least one second disc, wherein it may be provided that the ring encompasses the first and/or second disc).

In another configuration, it is provided that the fixed guide element is identical to the mold-side fixed connector or is indirectly or directly fixed thereto.

In another configuration, the first mold is a lower mold and/or the second mold is an upper mold.

In another configuration, the maximum pressure with which the first mold and the second mold are pressed together is no less than 20,000 N.

In another configuration, the maximum pressure with which the first mold and the second mold are pressed together is no greater than 100,000 N.

In another configuration, the maximum pressure with which the first mold and the second mold are pressed together is no greater than 200,000 N.

In another configuration, the blank made of glass is placed onto a for example annular support surface of a carrier body, for example having a hollow cross section, and is arranged on the carrier body in a cavity in a protective cover, which is arranged in a furnace cavity, and is for example heated such that a temperature gradient is produced in the blank such that the blank is cooler in its interior than in and/or on its outer region, wherein the blank made of glass, after being heated, is blank-pressed, for example on both sides, to form the optical element.

In another configuration, the protective cover is removably arranged in the furnace cavity.

In another configuration, the protective cover is removed once a or the blank is placed in the furnace cavity, wherein e.g. another protective cover is arranged in the furnace cavity.

In one configuration, the blank is moved into the cavity in the protective cover from above or from the side. In another configuration, however, the blank is moved into the cavity in the protective cover from below.

In another configuration, the furnace cavity comprises at least one heating coil, which surrounds the protective cover in the furnace cavity (at least) in part, wherein it is provided that the interior of the protective cover is heated by means of the at least one heating coil.

In another configuration, the furnace cavity comprises at least two heating coils, which can be actuated separately from one another and surround the protective cover in the furnace cavity at least in part, wherein the interior of the protective cover is heated by means of the at least two heating coils.

In another configuration, the protective cover is made of silicon carbide or at least comprises silicon carbide.

In another configuration, the furnace cavity is part of the furnace assembly, for example in the form of a carousel, having a plurality of furnace cavities, in each of which a protective cover is arranged. Because the protective covers can be rapidly replaced when positioning a blank, not only is the standstill time shortened, meaning that costs are reduced, but the quality of the optical component is also improved, since the fact that they can be rapidly replaced reduces any disruptive influences during heating or warming. This effect can be further improved by the opening in the cavity of the protective cover, which points downwards, being closed or partially closed by a closure, wherein the closure can be detached and removed by loosening a fixing means, for example one or more screws. It is for example provided here that the protective cover falls out of the furnace cavity after detaching and removing the lower cover. This ensures that a furnace or hood-type annealing furnace is put back into operation particularly rapidly.

In another configuration, the support surface is cooled by means of a coolant flowing through the carrier body. In another configuration, the support surface spans a base surface that is not circular. In this case, a geometry of the support surface or a geometry of the base surface of the support surface is for example provided which corresponds to the geometry of the blank (to be heated), wherein the geometry is selected such that the blank rests on the outer region of its underside (underside base surface). The diameter of the underside or the underside base surface of the blank is at least 1 mm greater than the diameter of the base surface spanned (by the carrier body or its support surface). In this sense, it is for example provided that the geometry of the surface of the blank facing the carrier body or the underside base surface of the blank corresponds to the support surface or the base surface of the carrier body. This for example means that, after pressing or blank-pressing, the part of the blank resting on the carrier body or contacting the carrier body during heating is arranged in an edge region of the headlight lens which lies outside the optical path and rests on a transport element (see below) or its (corresponding) support surface, for example.

An annular support surface may comprise small discontinuities. Within the meaning of this disclosure, a base surface for example includes an imaginary surface (in the region of which the blank resting on the carrier body is not in contact with the carrier body), which lies in the plane of the support surface and is surrounded by this support surface, and the (actual) support surface. It is for example provided that the blank and the carrier body are coordinated with one another. This is for example understood to mean that the edge region of the blank rests on the carrier body on its underside. An edge region of a blank can be understood to mean the outer 10% or the outer 5% of the blank or its underside, for example.

In another configuration, the base surface is polygon-shaped or polygonal, but for example with rounded corners, wherein it is for example provided that the underside base surface of the blank is also polygon-shaped or polygonal, but for example with rounded corners. In another configuration, the base surface is triangle-shaped or triangular, but for example with rounded corners, wherein it is for example provided that the underside base surface of the blank is also triangle-shaped or triangular, but for example with rounded corners. In one configuration, the base surface is rectangle-shaped or rectangular, but for example with rounded corners, wherein it is for example provided that the underside base surface of the blank is also rectangle-shaped or rectangular, but for example with rounded corners. In another configuration, the base surface is square, but for example with rounded corners, wherein it is for example provided that the underside base surface of the blank is also square, but for example with rounded corners. In another configuration, the base surface is oval, wherein it is for example provided that the underside base surface of the blank is also oval.

In another configuration, the carrier body is tubular at least in the region of the support surface. The carrier body for example consists (at least substantially) of steel or high-alloy steel (i.e. for example a steel in which the average mass content of at least one alloy element is >5%) or of a tube made of steel or high-alloy steel. In another configuration, the diameter of the hollow cross section of the carrier body or the internal tube diameter, at least in the region of the support surface, is no less than 0.5 mm and/or no greater than 1 mm. In another configuration, the external diameter of the carrier body or the external tube diameter, at least in the region of the support surface, is no less than 2 mm and/or no greater than 4 mm, for example no greater than 3 mm. In another configuration, the radius of curvature of the support surface orthogonally to the flow direction of the coolant is no less than 1 mm and/or no greater than 2 mm, for example no greater than 1.5 mm. In another configuration, the ratio of the diameter of the hollow cross section of the carrier body, at least in the region of the support surface, to the external diameter of the carrier body, at least in the region of the support surface, is no less than ¼ and/or no greater than ½. In another configuration, the carrier body is uncoated at least in the region of the support surface. In another configuration, coolant flows through the carrier body in accordance with the counterflow principle. In another configuration, the coolant is additionally and/or actively heated. In another configuration, the carrier body comprises at least two flow channels for the coolant flowing therethrough, which each only extend over a section of the annular support surface, wherein it is for example provided that two flow channels are connected in a region in which they leave the support surface by means of metal filler material, for example solder.

Within the meaning of this disclosure, a blank is for example a portioned glass part or a preform or a gob.

The method described may also be carried out in connection with pressing under vacuum or near vacuum or at least under negative pressure. Within the meaning of this disclosure, negative pressure is for example a pressure that is no greater than 0.5 bar, for example no greater than 0.3 bar, for example no less than 0.1 bar, for example no less than 0.2 bar. Within the meaning of this disclosure, vacuum or near vacuum is for example a pressure that is no greater than 0.1 bar, for example no greater than 0.01 bar, for example no greater than 0.001 bar. Within the meaning of this disclosure, vacuum or near vacuum is for example a pressure that is no less than 0.01 bar, for example no less than 0.001 bar, for example no less than 0.0001 bar.

Suitable methods are for example disclosed in JP 2003-048728 A (incorporated by reference in its entirety) and in WO 2014/131426 A1 (incorporated by reference in its entirety). In a corresponding configuration, a bellows may be provided, as disclosed in WO 2014/131426 A1, at least in a similar manner. It may be provided that the pressing of the optical element is carried out in such a way by means of the first mold and the second mold,
(a) wherein a heated blank made of transparent material is placed in or on the first mold,
(b) wherein (subsequently or thereafter) the second mold and the first mold (are positioned relative to one another and) are moved towards one another without the second mold and the first mold forming a closed overall mold,
(c) wherein (subsequently or thereafter) a seal for producing an airtight space, in which the second mold and the first mold are arranged, is closed,
(d) wherein (subsequently or thereafter) a negative pressure or near vacuum or vacuum is generated in the airtight space,
(e) and wherein (subsequently or thereafter) the second mold and the first mold are moved towards one another (for example vertically) for (blank) pressing the optical (lens) element (for example on both sides or all sides), wherein it is for example provided that the second mold and the first mold form a closed overall mold.

The second mold and the first mold can be moved towards one another by the second mold being (vertically) moved towards the first mold and/or the first mold being (vertically) moved towards the second mold.

For pressing, the second mold and the first mold are for example moved towards one another until they come into contact and form a closed overall mold.

In another configuration, in step (b) the second mold and the first mold are for example brought together such that the distance (for example the vertical distance) between the second mold and the blank is no less than 4 mm and/or no greater than 10 mm.

In another configuration, a bellows is arranged between the movable connector of the first mold and the movable guide element of the second mold such that a negative pressure or near vacuum or vacuum can be generated in the space enclosed by the bellows, and therefore the blank is pressed under negative pressure or near vacuum or vacuum. Alternatively, a chamber may also be provided which surrounds the first mold, the second mold and the blank such that the blank is pressed under negative pressure or near vacuum or vacuum.

In another configuration
(f) (following step (e) or after step (e)) normal pressure is generated in the airtight space. Within the meaning of this disclosure, normal pressure is for example atmospheric (air) pressure. Within the meaning of this disclosure, normal pressure is for example the pressure or air pressure prevailing outside the seal. Subsequently or thereafter, in another configuration the seal is opened or returned to its starting position.

In another configuration
(g) (following step (f) or after step (f) or during step (f)) the second mold and the first mold are moved away from one another. The second mold and the first mold can be moved away from one another by the second mold being moved away from the first mold and/or the first mold being moved away from the second mold. Subsequently or thereafter, in another configuration the optical element is removed. Subsequently or thereafter, in another configuration the optical element is cooled in accordance with a predetermined cooling regime (see below).

In another configuration, before pressing the optical (lens) element (or between step (d) and step (e)), a predetermined waiting time is allowed to elapse. In another configuration, the predetermined waiting time is no greater than 3 seconds (minus the duration of step (d)). In another configuration, the predetermined waiting time is no less than 1 second (minus the duration of step (d)).

In another configuration, it is provided that, after blank-pressing, the optical element is placed on a transport element and passes through an annealing kiln on the transport element without an optical surface of the optical element being contacted. Within the meaning of this disclosure, an annealing kiln (for example for cooling optical elements) is for example used for the controlled cooling of the optical element (for example with the addition of heat). Exemplary cooling regimes may e.g. be found in “Werkstoffkunde Glas” [Glass Materials Science], 1^{st} edition, VEB Deutscher Verlag für Grundstoffindustrie, Leipzig VLN 152-915/55/75, LSV 3014, editorial deadline: Jan. 9, 1974, order number: 54107, e.g. page 130 and “Glastechnik—BG 1/1—Werkstoff Glas” [Glass Technology—vol. 1/1—Glass: The Material], VEB Deutscher Verlag für Grundstoffindustrie, Leipzig 1972, e.g. page 61 ff (incorporated by reference in its entirety).

The transport element or the corresponding support surface of the transport element is annular, for example, but is not circular, for example. In another configuration, the corresponding support surface surrounds a recess having a passage surface, which is for example the surface formed by the recess in a plan view of the transport element. The geometric shape of the passage surface for example approximately or substantially corresponds to the geometric shape of the base surface. In one configuration, the passage surface is polygon-shaped or polygonal, but for example with rounded corners. In another configuration, the base surface is triangle-shaped or triangular, but for example with rounded corners. In another configuration, the base surface is rectangle-shaped or rectangular, but for example with rounded corners. In another configuration, the base surface is square, but for example with rounded corners. In another configuration, the base surface is oval.

Within the meaning of this disclosure, an optical element is for example an element for the targeted orientation of light by refraction. Within the meaning of this disclosure, an optical element is for example an element for the targeted orientation of light by refraction on an optically active light entry surface and/or on an optically active light exit surface. Within the meaning of this disclosure, an optical element is for example an (optical) lens, for example a headlight lens or a lens-like free-form. Within the meaning of this disclosure, an optical element is for example a lens or a lens-like free-form comprising a supporting edge that is circumferential, discontinuous or circumferential in a discontinuous manner. Within the meaning of this disclosure, an optical element may e.g. be an optical element as described in WO 2017/059945 A1, WO 2014/114309 A1, WO 2014/114308 A1, WO 2014/114307 A1, WO 2014/072003 A1, WO 201 3/1 7831 1 A1, WO 2013/170923 A1, WO 2013/159847 A1, WO 2013/123954 A1, WO 2013/135259 A1, WO 2013/068063 A1, WO 2013/068053 A1, WO 2012/130352 A1, WO 2012/072187 A2, WO 2012/072188 A1, WO 2012/072189 A2, WO 2012/072190 A2, WO 2012/072191 A2, WO 2012/072192 A1, WO 2012/072193 A2, or PCT/EP2017/000444, for example. Each of these documents is incorporated by reference in its entirety. For pressing optical elements or headlight lenses of this kind, a pressing method and a corresponding pressing device as disclosed in the German patent application 10 2020 115 083.0 comes into consideration, for example.

In another configuration, it is provided that, after blank-pressing, the optical element is placed on a transport element, is sprayed with surface-treatment agent on the transport element and, thereafter or subsequently, passes through a or the annealing kiln on the transport element without an optical surface of the optical element being contacted (see above). It is necessary to comply with a cooling regime of this kind in order to prevent any internal stresses within the optical element or the headlight lens, which, although they are not visible upon visual inspection, can sometimes significantly impair the lighting properties as an optical element of a headlight lens. These impairments can result in a corresponding optical element or headlight lens becoming unusable.

In another configuration, the transport element consists of steel. For clarification: the transport element is not part of the optical element (or headlight lens), and the optical element (or headlight lens) and the transport element are not part of a common, integral body.

In another configuration, the transport element is heated, for example inductively, before receiving the optical element. In another configuration, the transport element is heated at a heating rate of at least 20 K/s, for example of at least 30 K/s. In another configuration, the transport element is heated at a heating rate of no greater than 50 K/s. In another configuration, the transport element is heated by means of an energized winding/coil which is arranged above the transport element.

In another configuration, the optical element comprises a support surface, which lies outside the light path provided for the optical element, wherein the support surface, for example only the support surface, is in contact with a corresponding support surface of the transport element when the optical element is placed on the transport element. In another configuration, the support surface of the optical element is on the edge of the optical element. In another configuration, the transport element comprises at least one limiting surface for orienting the optical element on the transport element and for limiting or preventing a movement of the optical element on the transport element. In one configuration, the limiting surface or surfaces are provided above the corresponding support surface of the transport element. In another configuration, (at least) two limiting surfaces are provided, wherein it may be provided that one limiting surface is below the corresponding support surface of the transport element and one limiting surface is above the corresponding support surface of the transport element. In another configuration, the transport element is adapted, i.e. manufactured, for example milled, to the optical element or the support surface of the optical element.

The transport element or the support surface of the transport element is annular, for example, but is not circular, for example.

In another configuration, the preform is produced, cast and/or molded from molten glass. In another configuration, the mass of the preform is 10 g to 400 g, for example 20 g to 250 g.

In another configuration, the temperature gradient of the preform is set such that the temperature of the core of the preform is above 10 K+T_{G}.

In another configuration, to reverse its temperature gradient, the preform is first cooled, for example with the addition of heat, and then heated, wherein it is also provided that the preform is heated such that the temperature of the surface of the preform after heating is at least 100 K, for example at least 150 K, higher than the glass transition temperature T_{G}. The glass transition temperature T_{G} is the temperature at which the glass becomes hard. Within the meaning of this disclosure, the glass transition temperature T_{G} is for example intended to be the temperature of the glass at which it has a viscosity in a range around 13.3 dPas (corresponding to 10^{13.3} Pas). In relation to the glass type according to FIG. 15, the transition temperature T_{G} is approximately 538° C.

In another configuration, the temperature gradient of the preform is set such that the temperature of the upper surface of the preform is at least 30 K, for example at least 50 K, above the temperature of the lower surface of the preform. In another configuration, the temperature gradient of the preform is set such that the temperature of the core of the preform is at least 50 K below the temperature of the surface of the preform. In another configuration, the preform is cooled such that temperature of the preform before the heating is T_{G}−80 K to T_{G}+30 K. In another configuration, the temperature gradient of the preform is set such that the temperature of the core of the preform is 480° C. to 585° C. The temperature gradient is also set such that the temperature in the core of the preform is below T_{G} or close to T_{G}. In another configuration, the temperature gradient of the preform is set such that the temperature of the surface of the preform is 750° C. to 1020° C., for example 800° C. to 900° C. In another configuration, the preform is heated such that its surface assumes a temperature (for example immediately before pressing) that corresponds to the temperature at which the glass of the preform has a viscosity between 5 dPas (corresponding to 10⁵ Pas) and 8 dPas (corresponding to 10⁸ Pas), for example a viscosity between 5.5 dPas (corresponding to 10^{5.5} Pas) and 7 dPas (corresponding to 10⁷ Pas).

It is for example provided that, before reversing the temperature gradient, the preform is removed from a mold for molding or producing the preform. It is for example provided that the temperature gradient is reversed outside a mold. Within the meaning of this disclosure, cooling with the addition of heat for example means that cooling is carried out a temperature of greater than 100° C.

One configuration also relates to a device for carrying out the above-mentioned methods.

Within the meaning of this disclosure, blank-pressing is for example understood to mean pressing a (for example optically active) surface such that subsequent finishing of the contour of this (for example optically active) surface is or can be omitted or is not provided. It is thus for example provided that a blank-pressed surface is not polished after the blank-pressing. Polishing, which influences the surface finish but not the contours of the surface, may be provided in some cases. Blank-pressing on both sides can for example be understood to mean that a (for example optically active) light exit surface is blank-pressed and a (for example optically active) light entry surface that is for example opposite the (for example optically active) light exit surface is likewise blank-pressed.

Within the meaning of this disclosure, blank-pressing solely relates to (optically active) surfaces that are used for influencing light in a targeted manner. Within the meaning of this disclosure, blank-pressing therefore does not relate to pressing of surfaces that are not used for influencing light passing therethrough in a targeted and/or intended manner. This means that, for the use of the term “blank-pressing” within the meaning of the claims, it is unimportant whether or not the surfaces that are not used for optically influencing light or for influencing light according to the use are finished.

In one configuration, the blank is placed onto an annular support surface of a carrier body having a hollow cross section, and is heated on the carrier body such that a temperature gradient is produced in the blank such that the blank is cooler in its interior than on its outer region, wherein the support surface is cooled by means of a coolant flowing through the carrier body, wherein the blank made of glass, after being heated, is blank-pressed, for example on both sides, to form the optical element, wherein the carrier body comprises at least two flow channels for the coolant flowing therethrough, which each only extend over a section of the annular support surface, and wherein two flow channels are connected in a region in which they leave the support surface by means of metal filler material, for example solder.

Within the meaning of this disclosure, a guide rod may be a rod, a tube, a profile, or the like.

Within the meaning of this disclosure, “fixed” for example means directly or indirectly fixed to a base of the pressing station or the press or a base on which the pressing station or press stands. Within the meaning of this disclosure, two elements are then fixed to one another, for example, when it is not provided that they are moved relative to one another for pressing.

For pressing, the first and the second mold are for example moved towards one another such that they form a closed mold or cavity or a substantially closed mold or cavity. Within the meaning of this disclosure, “moved towards one another” for example means that both molds are moved. It may, however, also mean that only one of the two molds is moved.

Within the meaning of the disclosure, a recess for example includes a bearing that couples or connects the recess to the corresponding guide rod. Within the meaning of this disclosure, a recess may be widened to form a sleeve or may be designed as a sleeve. Within the meaning of this disclosure, a recess may be widened to form a sleeve comprising an inner bearing or may be designed as a sleeve comprising an inner bearing.

In a matrix headlight, the optical element or a corresponding headlight lens is for example used as front optics and/or as a secondary lens for imaging a or the front optics. Within the meaning of this disclosure, front optics are for example arranged between the secondary optics and a light-source assembly. Within the meaning of this disclosure, front optics are for example arranged in the light path between the secondary optics and the light-source assembly. Within the meaning of this disclosure, front optics are for example an optical component for forming a light distribution depending on the light that is generated by the light-source assembly and is directed therefrom into the front optics. Here, a light distribution is generated or formed for example by TIR, i.e. by total reflection.

The (proposed) optical element or a corresponding lens is also used in a projection headlight, for example. In the configuration as a headlight lens for a projection headlight, the optical element or a corresponding lens forms the edge of a light stop in the form of a cut-off line on the carriageway.

Furthermore, particularly suitable applications for the above-mentioned optical elements are intended to be provided.

One configuration relates to a method for producing a vehicle headlight, wherein an optical element produced according to a method having one or more of the above-mentioned features is installed in a headlight housing.

One configuration relates to a method for producing a vehicle headlight, wherein an optical element produced according to a method having one or more of the above-mentioned features is placed in a headlight housing and is installed together with at least one light source or a plurality of light sources to form a vehicle headlight.

One configuration relates to a method for producing a vehicle headlight, wherein an optical element produced according to a method having one or more of the above-mentioned features is installed (in a headlight housing) together with at least one light source and a light stop to form a vehicle headlight such that an edge of the light stop can be imaged by the (automotive) lens element as a cut-off line by means of light emitted by the light source.

One configuration relates to a method for producing a vehicle headlight, wherein an optical element produced according to a method having one or more of the above-mentioned features is placed in a headlight housing in the form of secondary optics or as part of secondary optics comprising a plurality of lenses for imaging a light output surface of front optics and/or an illumination pattern generated by means of primary optics and is installed together with at least one light source or a plurality of light sources and the front optics to form a vehicle headlight.

One configuration relates to a method for producing a vehicle headlight, wherein primary optics or a front optics array is produced as primary optics for generating the illumination pattern according to a method having one or more of the above-mentioned features.

One configuration relates to a method for producing a vehicle headlight, wherein the primary optics comprise a system of movable micromirrors, for example a system of more than 100,000 movable micromirrors, for example a system of more than 1,000,000 movable micromirrors, for generating the illumination pattern.

One configuration relates to a method for producing an objective lens, wherein at least one first lens is produced according to a method having one or more of the above-mentioned features and is then installed in an objective lens and/or an objective housing. In another configuration, at least one second lens is produced according to a method having one or more of the above-mentioned features and is then installed in an objective lens and/or an objective housing. In another configuration, at least one third lens is produced according to a method having one or more of the above-mentioned features and is then installed in an objective lens and/or an objective housing. In another configuration, at least one fourth lens is produced according to a method having one or more of the above-mentioned features and is then installed in an objective lens and/or an objective housing.

One configuration relates to a method for producing a camera, wherein an objective lens produced according to a method having one or more of the above-mentioned features is installed together with a sensor or light-sensitive sensor such that an object can be imaged on the sensor by means of the objective lens. The above-mentioned objective lens and/or the above-mentioned camera can be used as a sensor system or a surround sensor system for use for vehicle headlights, such as the above-mentioned vehicle headlights, and/or in driver assistance systems.

One configuration relates to a method for producing a microprojector or a microlens array, wherein the microlens array is produced according to an above-mentioned method having one or more of the above-mentioned features. In order to produce a projection display, the microlens array comprising a large number of microlenses and/or projection lenses arranged on a carrier or substrate is installed together with object structures and a light source, for example for illuminating the object structures. The method is used in microlens arrays having a large number of microlenses and/or projection lenses on a planar base surface, but furthermore also on a curved base surface. It is for example provided that the object structures are arranged on the carrier or substrate (on a side of the carrier or substrate facing away from the microlenses and/or projection lenses).

It may be provided that the microlens array is pressed according to an above-mentioned method having one or more of the above-mentioned features and that the microlenses do not remain on the carrier or substrate as a whole, but instead the microlenses or projection lenses are separated.

Within the meaning of this disclosure, microlenses may be lenses having a diameter of no greater than 1 cm. Within the meaning of this disclosure, microlenses may, however, be lenses having a diameter of no greater than 1 mm, for example. Within the meaning of this disclosure, microlenses may be lenses having a diameter of no less than 0.1 mm.

In another configuration, it is provided that the maximum deviation of the actual value from the target value of the distance between two optically active surfaces of the optical element is no greater than 40 μm, for example no greater than 30 μm, for example no greater than 20 μm, for example no less than 2 μm. In another configuration, it is provided that the maximum deviation of the actual value from the target value of the distance between an optically active surface and a plane orthogonal to the optical axis of the optically active surface, wherein this plane includes the geometric centroid of the optical element, is no greater than 20 μm, for example no greater than 15 μm, for example no greater than 8 μm, for example no less than 1 μm. In another configuration, it is provided that the RMSt value (total surface form deviation) according to DIN ISO 10110-5 of April 2016 for the optically active surfaces of the optical element, for at least one optically active surface of the optical element and/or for at least two optically active surfaces of the optical element, is no greater than 12 μm, for example no greater than 10 μm, for example no greater than 8 μm, for example no greater than 6 μm, for example no greater than 4 μm, for example no greater than 2 μm, for example no less than 0.5 μm.

Within the meaning of this disclosure, a motor vehicle is for example a land vehicle that can be used individually in road traffic. Within the meaning of this disclosure, motor vehicles are not limited to land vehicles comprising internal combustion engines, for example.

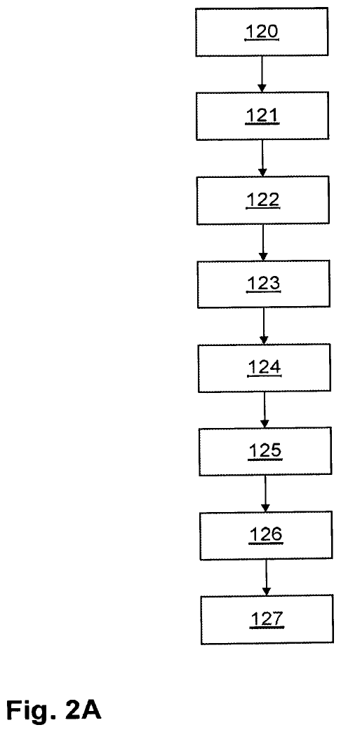

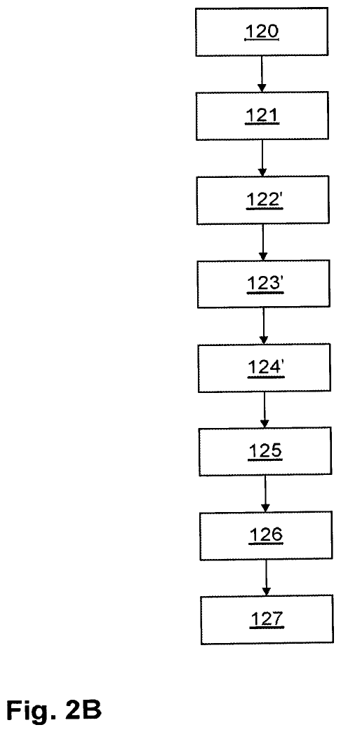

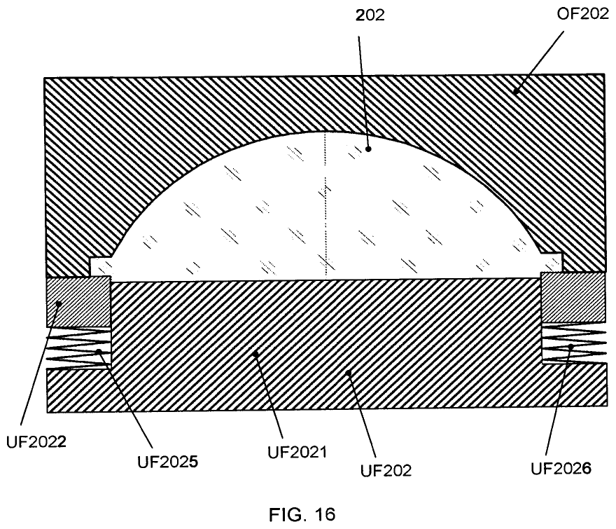

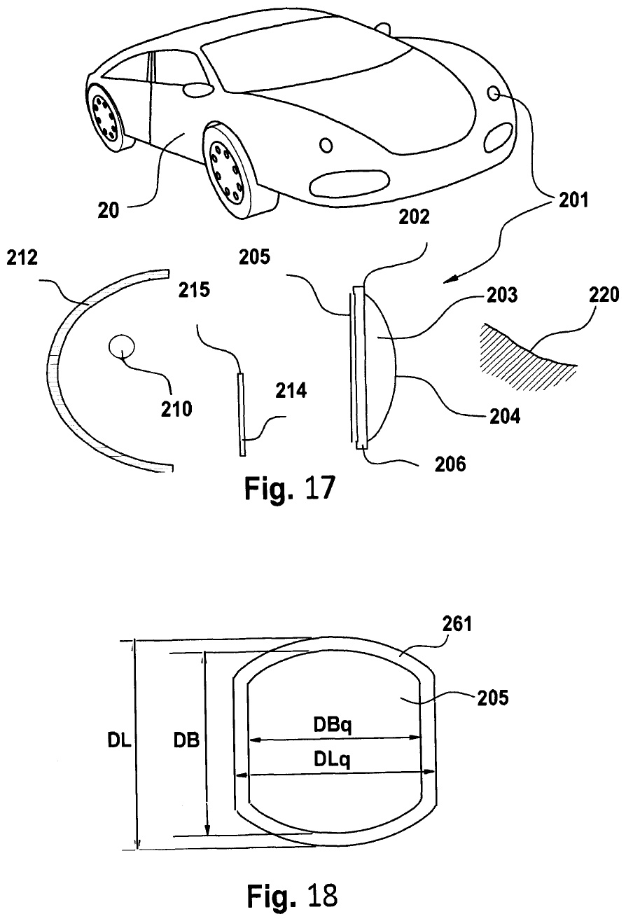

FIG. 1 and FIG. 1A and 1B show a schematically shown device 1 or 1A and 1B for carrying out a method shown in FIG. 2A or 2B for producing optical elements, such as optical lenses, for example motor-vehicle headlight lenses, such as the (motor-vehicle) headlight lens 202 shown schematically in FIG. 17, or (lens-like) free-forms, for example for motor-vehicle headlights, for example the use thereof as described in the following with reference to FIG. 17.

FIG. 17 is a schematic view of a motor-vehicle headlight 201 (projection headlight) of a motor vehicle 20, comprising a light source 210 for generating light, a reflector 212 for reflecting light that can be generated by means of the light source 210, and a light stop 214. The motor-vehicle headlight 201 also comprises a headlight lens 202 for imaging an edge 215 of the light stop 214 as a cut-off line 220 by means of light that can be generated by the light source 210. Typical requirements placed on the cut-off line or on the light distribution taking into account or incorporating the cut-off line are disclosed e.g. in Bosch—Automotive Handbook, 9^{th} edition, ISBN 978-1-119-03294-6, page 1040. Within the meaning of this disclosure, a headlight lens is e.g. a headlight lens by means of which a cut-off line can be generated, and/or a headlight lens by means of which the requirements according to Bosch—Automotive Handbook, 9^{th} edition, ISBN 978-1-119-03294-6 (incorporated by reference in its entirety), page 1040, can be met. The headlight lens 202 comprises a lens body 203 made of glass, which has a substantially planar (for example optically active) surface 205 facing the light source 210 and a substantially convex (for example optically active) surface 204 facing away from the light source 210. The headlight lens 202 also comprises a (for example circumferential) edge 206, by means of which the headlight lens 202 can be fastened in the motor-vehicle headlight 201. The elements in FIG. 17 are not necessarily shown to scale for the sake of simplicity and clarity. Therefore, for example, the scales of some elements are exaggerated compared with other elements in order to improve the understanding of the embodiment of the present disclosure.

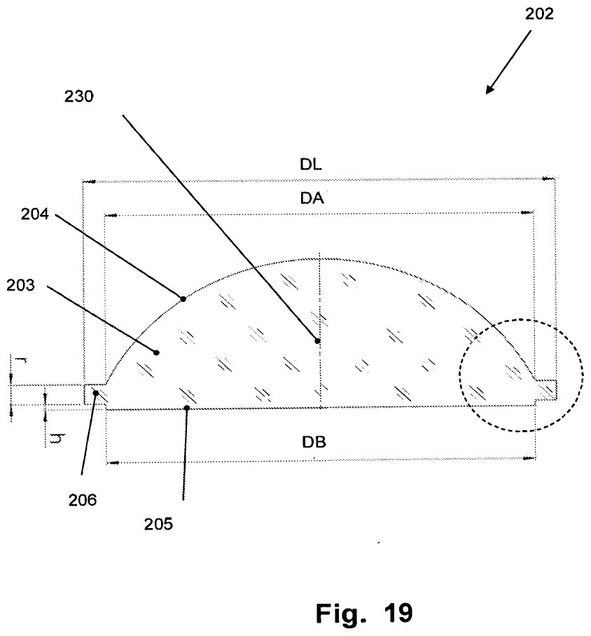

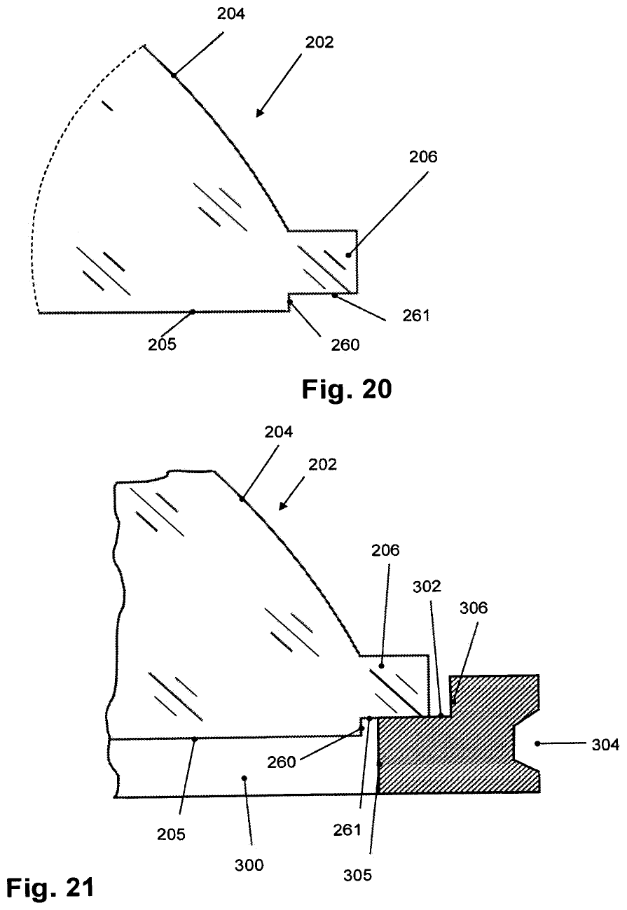

FIG. 18 is a view of the headlight lens 202 from below. FIG. 19 is a cross section through an embodiment of the headlight lens. FIG. 20 shows a detail of the headlight lens 202 marked by a dashed circle in FIG. 19. The planar (for example optically active) surface 205 projects in the form of a step 260 towards the optical axis 230 of the headlight lens 202 beyond the lens edge 206 or beyond the surface 261 of the lens edge 206 facing the light source 210, wherein the height h of the step 260 is e.g. no greater than 1 mm, furthermore no greater than 0.5 mm. The nominal value of the height h of the step 260 is furthermore 0.2 mm.

The thickness r of the lens edge 206 according to FIG. 19 is at least 2 mm, but no greater than 5 mm. According to FIGS. 18 and 19, the diameter DL of the headlight lens 202 is at least 40 mm, but no greater than 100 mm. The diameter DB of the substantially planar (for example optically active) surface 205 is equal to the diameter DA of the convex curved optically active surface 204. In another configuration, the diameter DB of the substantially planar optically active surface 205 is no greater than 110% of the diameter DA of the convex curved optically active surface 204. In addition, the diameter DB of the substantially planar optically active surface 205 is furthermore at least 90% of the diameter DA of the convex curved optically active surface 204. The diameter DL of the headlight lens 202 is furthermore approximately 5 mm greater than the diameter DB of the substantially planar optically active surface 205 and/or than the diameter DA of the convex curved optically active surface 204. The diameter DLq of the headlight lens 202 extending orthogonally to DL is at least 40 mm, but no greater than 80 mm, and is less than the diameter DL. The diameter DLq of the headlight lens 202 is furthermore approximately 5 mm greater than the diameter DBq that is orthogonal to DB.

In another configuration, the (optically active) surface 204 intended to face away from the light source and/or the (optically active) surface 205 intended to face the light source have a surface structure that scatters light (and is generated/pressed by molding). A suitable light-scattering surface structure e.g. includes modulation and/or (surface) roughness of at least 0.05 μm, for example at least 0.08 μm, and/or is configured as modulation optionally having an additional (surface) roughness of at least 0.05 μm, for example of at least 0.08 μm. Within the meaning of this disclosure, roughness is intended to be defined as Ra, for example in accordance with ISO 4287. In another configuration, the light-scattering surface structure may have a structure that simulates the surface of a golf ball or may be configured as a structure that simulates the surface of a golf ball. Suitable light-scattering surface structures are disclosed in DE 10 2005 009 556, DE 102 26 471 B4 and DE 299 14 114 U1, for example. Other configurations of light-scattering surface structures are disclosed in the German patent specification 1 099 964, DE 36 02 262 C2, DE 40 31 352 A1, U.S. Pat. No. 6,130,777, US 2001/0033726 A1, JP 10123307 A, JP 09159810 A, DE 11 2018 000 084.2 and JP 01147403 A.

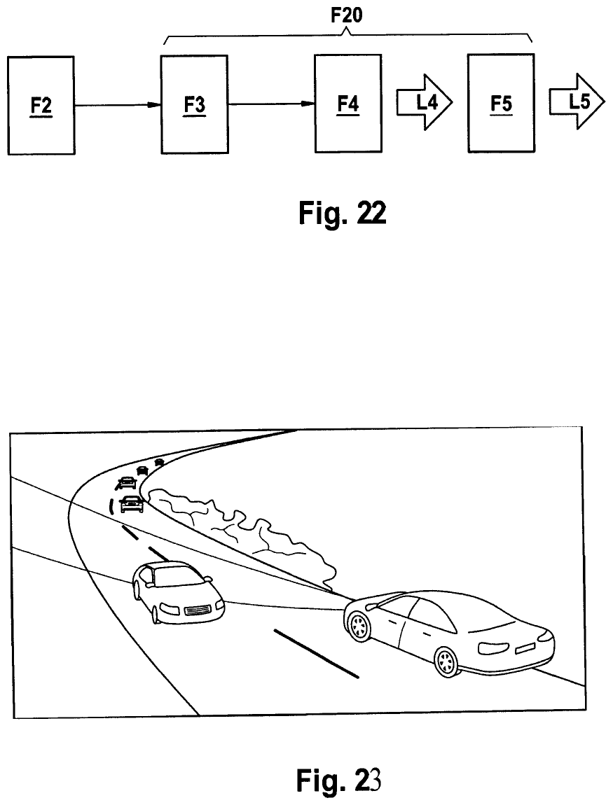

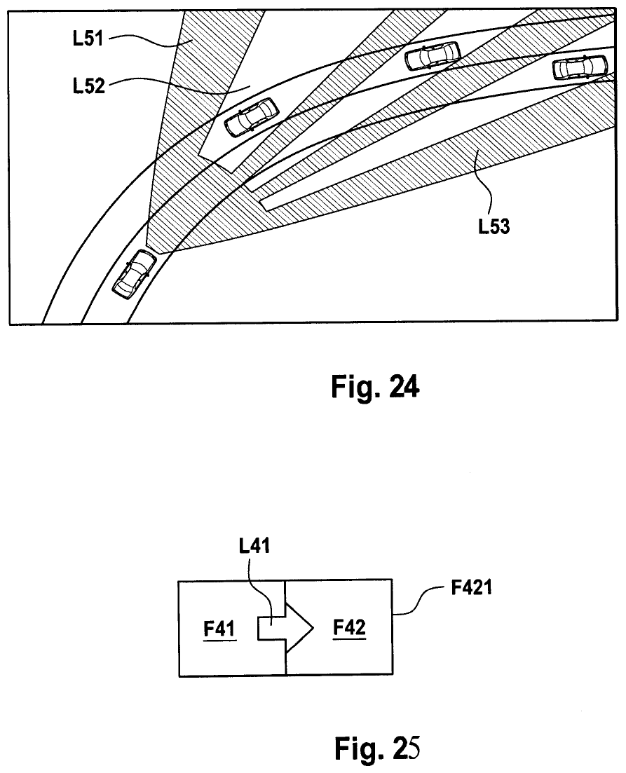

FIG. 22 shows an adaptive headlight or vehicle headlight F20 for the situation-dependent or traffic-dependent illumination of the surroundings or carriageway in front of the motor vehicle 20 on the basis of a surround sensor system F2 of the motor vehicle 20. For this purpose, the vehicle headlight F20 shown schematically in FIG. 22 comprises an illumination device F4, which is actuated by means of a controller F3 of the vehicle headlight F20. Light L4 generated by the illumination device F4 is emitted by the vehicle headlight F20 in the form of an illumination pattern L5 by means of an objective lens F5, which may comprise one or more optical lens elements or headlight lenses. Examples of corresponding illumination patterns are shown in FIGS. 23 and 24, and the websites web.archive.org/web/20150109234745/http://www.audi.de/content/de/brand/de/vorsp rung_durch_technik/content/2013/08/Audi-A8-erstrahlt-in-neuem-Licht.html (retrieved on May 9., 2019) and www.all-electronics.de/matrix-led-und-laserlicht-bietet-viele-vorteile/(retrieved on Feb. 9, 2019). In the configuration according to FIG. 24, the illumination pattern L5 comprises full-beam regions L51, dimmed regions L52 and cornering light L53.

FIG. 25 shows an embodiment of the illumination device F4, wherein it comprises a light-source assembly F41 having a plurality of individually adjustable regions or pixels. Therefore, up to 100 pixels, up to 1000 pixels or no less than 1000 pixels may for example be provided, which can be individually actuated by means of the controller F3 to the effect that they can be individually activated or deactivated, for example. It may be provided that the illumination device F4 also comprises front optics F42 for generating a light pattern (such as L4) on the light exit surface F421 on the basis of the accordingly actuated regions or pixels of the light-source assembly F41 or according to the light L41 directed into the front optics F42.

Within the meaning of this disclosure, matrix headlights may also be matrix SSL HD headlights. Examples of headlights of this kind are found at the links www.springerprofessional.de/fahrzeug-lichttechnik/fahrzeugsicherheit/hella-bringt -neues-ssl-hd-matrix-lichtsystem-auf-den-markt/17182758 (retrieved on 28 May 2020), www.highlight-web.de/5874/hella-ssl-hd/ (retrieved on 28 May 2020) and www.hella.com/techworld/de/Lounge/Unser-Digital-Light-SSL-HD-Lichtsystem -ein-neuer-Meilenstein-der-automobilen-Lichttechnik-55548/ (retrieved on 28 May 2020).

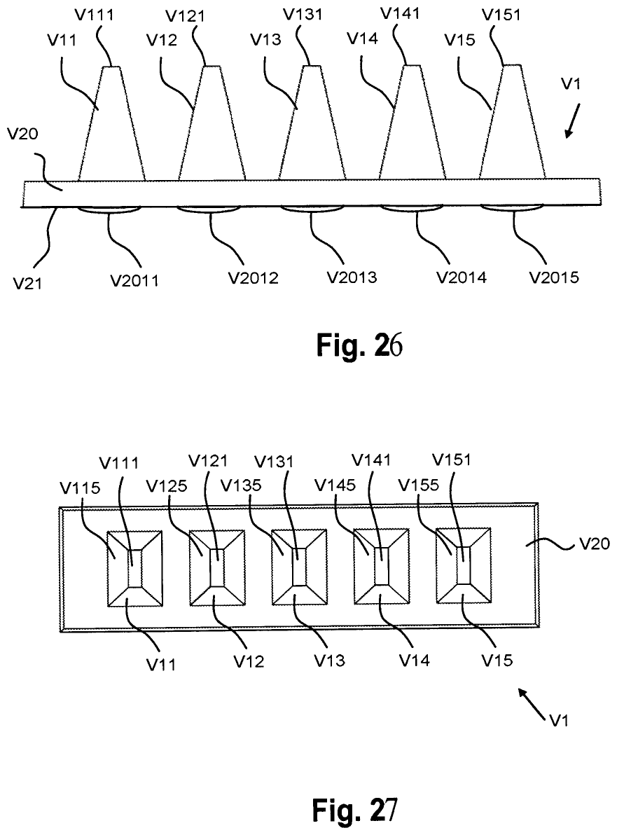

FIG. 26 is a side view of an integral front optics array V1. FIG. 27 is a rear plan view of the front optics array V1. The front optics array V1 comprises a base part V20, on which lenses V2011, V2012, V2013, V2014 and V2015 and front optics V11 having a light entry surface V111, front optics V12 having a light entry surface V121, front optics V13 having a light entry surface V131, front optics V14 having a light entry surface V141 and front optics V15 having a light entry surface V151 are molded. The side surfaces V115, V125, V135, V145, V155 of the front optics V11, V12, V13, V14, V15 are blank-pressed and are formed such that light which enters the relevant light entry surface V111, V121, V131, V141 or V151 by means of a light source is subjected to total reflection (TIR), such that this light exits the base part V20 or the surface V21 of the base part V20 which forms the common light exit surface of the front optics V11, V12, V13, V14 and V15. The rounding radii between the light entry surfaces V111, V121, V131, V141 and V151 at the transition to the side surface V115, V125, V135, V145 and V155 are e.g. 0.16 to 0.2 mm.

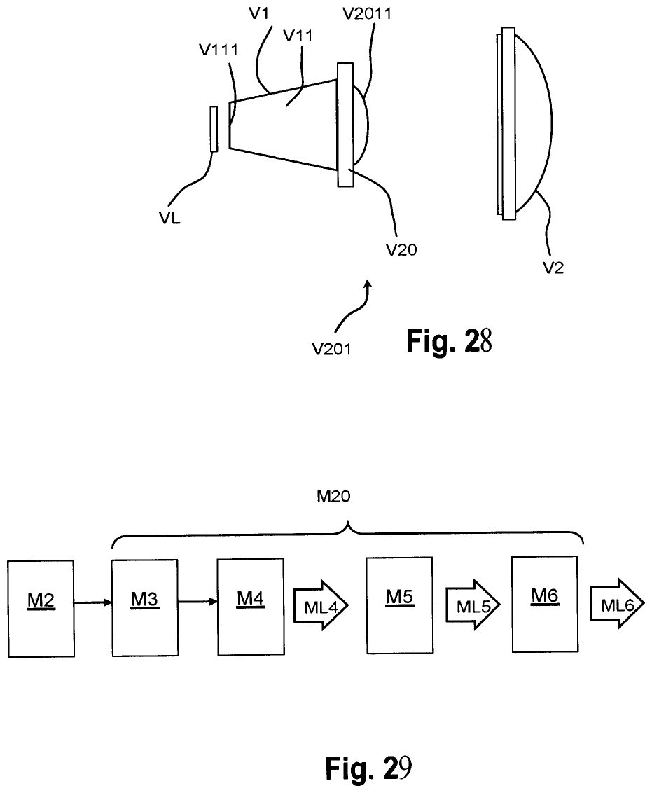

FIG. 28 is a schematic view of a vehicle headlight V201 or motor-vehicle headlight. The vehicle headlight V201 comprises a light-source assembly VL, for example comprising LEDs, for directing light into the light entry surface V111 of the front optics V11 or the light entry surfaces V112, V113, V114 and V115 (not shown in greater detail) of the front optics V12, V13, V14 and V15. In addition, the vehicle headlight V201 comprises a secondary lens V2 for imaging the light exit surface V21 of the front optics array V1.

Another suitable field of application for lenses produced in this way is for example disclosed in DE 10 2017 105 888 A1 or the headlight described with reference to FIG. 29. In this case, by way of example, FIG. 29 shows a light module (headlight) M20 which comprises a light-emission unit M4 having a plurality of punctiform light sources that are arranged in a matrix-like manner and each emit light ML4 (with a Lambert's emission characteristic), and also comprises a concave lens M5 and projection optics M6. In the example according to FIG. 29 shown in DE 10 2017 105 888 A1, the projection optics M6 comprise two lenses which are arranged one behind the other in the beam path and have been produced according to a method corresponding the above-mentioned method. The projection optics M6 image the light ML4 emitted by the light-emission unit M4 and light ML5 that is further shaped after passing through the concave lens M5, in the form of a resulting light distribution ML6 of the light module M20, on a carriageway in front of the motor vehicle in which the light module or headlight is (has been) installed.

The light module M20 comprises a controller denoted by reference sign M3, which actuates the light-emission unit M4 on the basis of the values from a sensor system or surround sensor system M2. The concave lens M5 comprises a concave curved exit surface on the side facing away from the light-emission unit M4. The exit surface of the concave lens M5 deflects light ML4 directed into the concave lens M5 from the light-emission unit M4 at a large emission angle towards the edge of the concave lens by means of total reflection, such that said light is not transmitted through the projection optics M6. According to DE 10 2017 105 888 A1, light beams that are emitted from the light-emission unit M4 at a “large emission angle” are referred to as those light beams which (without arranging the concave lens M5 in the beam path) would be imaged poorly, for example in a blurred manner, on the carriageway by means of the projection optics M6 owing to optical aberrations and/or could result in scattered light, which reduces the contrast of the imaging on the carriageway (see also DE 10 2017 105 888 A1). It may be provided that the projection optics M6 can only image light in focus at an opening angle limited to approximately +/−20°. Light beams having opening angles of greater than +/−20°, for example greater than +/−30°, are therefore prevented from impinging on the projection optics M6 by arranging the concave lens M5 in the beam path.

The light-emission unit M4 may be designed differently. According to one configuration, the individual punctiform light sources of the light-emission unit M4 each comprise a semiconductor light source, for example a light-emitting diode (LED). The LEDs may be actuated individually or in groups in a targeted manner in order to activate or deactivate or dim the semiconductor light sources. The light module M20 e.g. comprises more than 1,000 individually actuatable LEDs. For example, the light module M20 may be designed as what is known as a pAFS (micro-structured adaptive front-lighting system) light module.

According to an alternative option, the light-emission unit M4 comprises a semiconductor light source and a DLP or micromirror array, which comprises a large number of micromirrors which can be actuated and tilted individually, wherein each of the micromirrors forms one of the punctiform light sources of the light-emission unit M4. The micromirror array for example comprises at least 1 million micromirrors, which may for example be tilted at a frequency of up to 5,000 Hz.

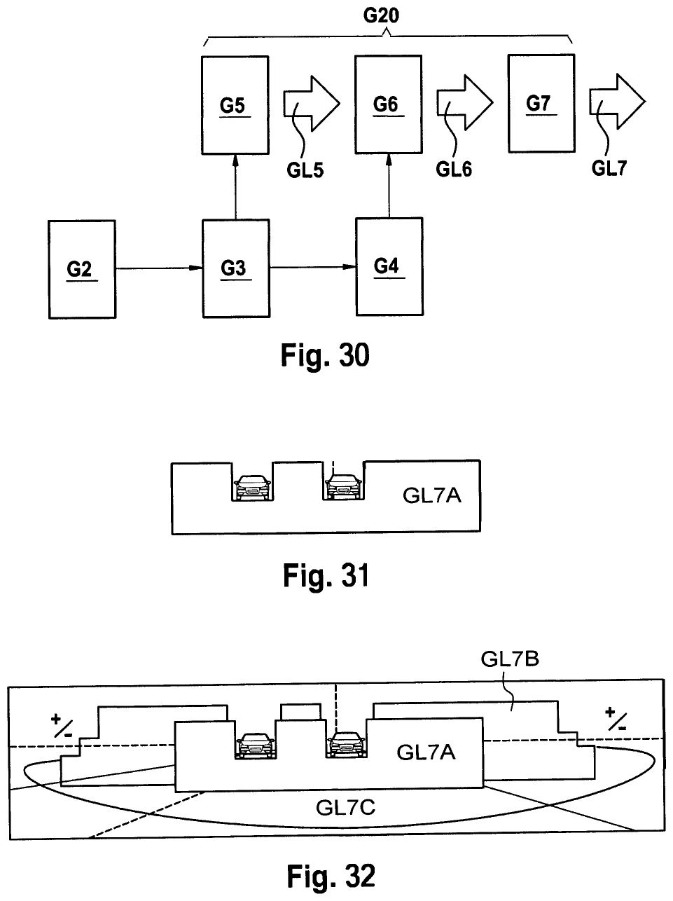

Another example of a headlight system or light module (DLP system) is disclosed by the link www.al-lighting.com/news/article/digital-light-millions-of-pixels-on-the-road/(retrieved on 13 Apr. 2020). FIG. 30 schematically shows a corresponding headlight module or vehicle headlight for generating an illumination pattern denoted as GL7A in FIG. 31. The adaptive headlight G20 schematically shown in FIG. 30 for the situation-dependent or traffic-dependent illumination of the surroundings or carriageway in front of the motor vehicle 20 on the basis of a surround sensor system G2 of the motor vehicle 20. Light GL5 generated by the illumination device G5 is shaped by means of a system of micromirrors G6, as also shown in DE 10 2017 105 888 A1, to form an illumination pattern GL6 which, by means of projection optics G7 for adaptive illumination, radiates suitable light GL7 in front of the motor vehicle 20 or in the surroundings onto the carriageway in front of the motor vehicle 20. A suitable system G6 of movable micromirrors is disclosed by the link www.al-lighting.com/news/article/digital-light-millions-of-pixels-on-the-road/ (retrieved on 13 Apr. 2020).

A controller G4 is provided for actuating the system G6 comprising movable micromirrors. In addition, the headlight G20 comprises a controller G3 both for synchronizing with the controller G4 and for actuating the illumination device G5 on the basis of the surround sensor system G2. Details of the controllers G3 and G4 can be found at the link www.al-lighting.com/news/article/digital-light-millions-of-pixels-on-the -road/ (retrieved on 13 Apr. 2020). The illumination device G5 may for example comprise an LED assembly or a comparative light-source assembly, optics such as a field lens (which, for example, has likewise been produced according to the above-described method) and a reflector.

The vehicle headlight G20 described with reference to FIG. 30 may for example be used in connection with other headlight modules or headlights in order to obtain a superimposed overall light profile or illumination pattern. This is shown by way of example in FIG. 32, wherein the overall illumination pattern is compiled from the illumination patterns GL7A, GL7B and GL7C. In this process, it may for example be provided that the illumination pattern GL7C is generated by means of the headlight 20 and the illumination pattern GL7B is generated by means of the headlight V201.

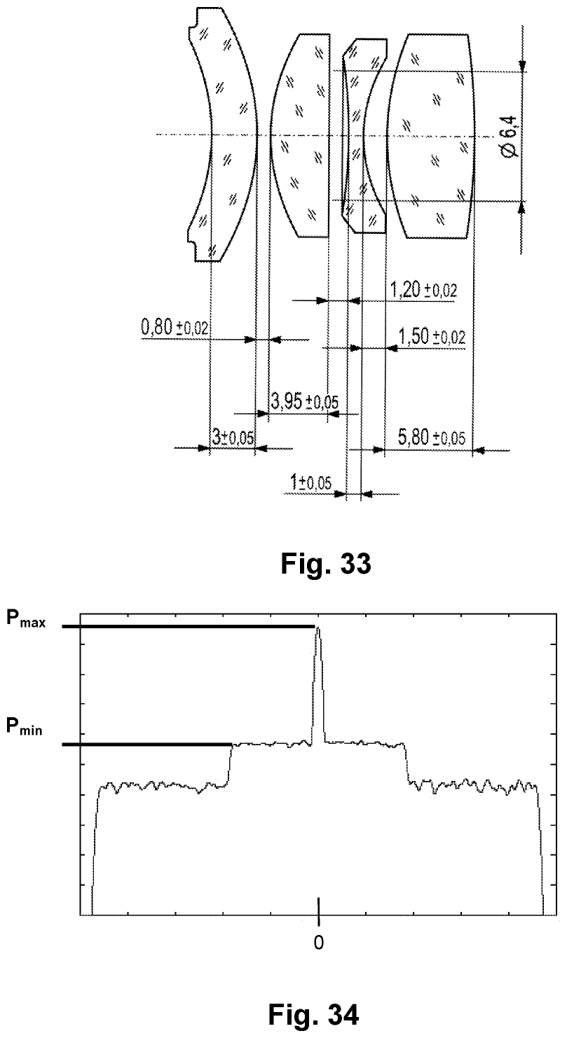

Sensor systems for the above-mentioned headlights for example comprise a camera and analysis or pattern recognition for analyzing a signal provided by the camera. A camera for example comprises an objective lens or a multiple-lens objective lens as well as an image sensor for imaging an image generated by the objective lens on the image sensor. In a particularly suitable manner, an objective lens is used as disclosed in U.S. Pat. No. 8,212,689 B2 (incorporated by reference in its entirety) and shown by way of example in FIG. 33. An objective lens is particularly suitable because it prevents or significantly reduces parasitic images, since an objective lens of this kind can for example prevent a parasitic image of a vehicle coming in the other direction with its lights on being confused with a vehicle driving in front with its lights on. A suitable objective lens, for example for infrared light and/or visible light, images an object in an image plane, wherein, in relation to the imaging of an object, it is applicable to each point within the image circle of the objective lens or to at least one point within the image circle of the objective lens that Pdyn>70 dB, for example Pdyn>80 dB, for example Pdyn>90 dB, wherein Pdyn is equal to 10·1og(Pmax/Pmn), as shown in FIG. 34, wherein Pmax is the maximum luminous power of a point in the image plane for imaging a point on the object, and wherein Pmin is the luminous power of another point in the image plane for imaging a point on the object, the luminous power of which in relation to the imaging of the object is greater than the luminous power of each other point in the image plane in relation to the imaging of the point on the object or wherein Pmin is the maximum luminous power of the parasitic-image signals from the point on the object as imaged at another point. The lenses or some of the lenses of the objective lens shown in FIG. 33 can be produced according to the claimed or disclosed method, wherein it is for example provided that the accordingly produced lenses comprise a circumferential or partially circumferential edge, in a departure from the view in FIG. 33.

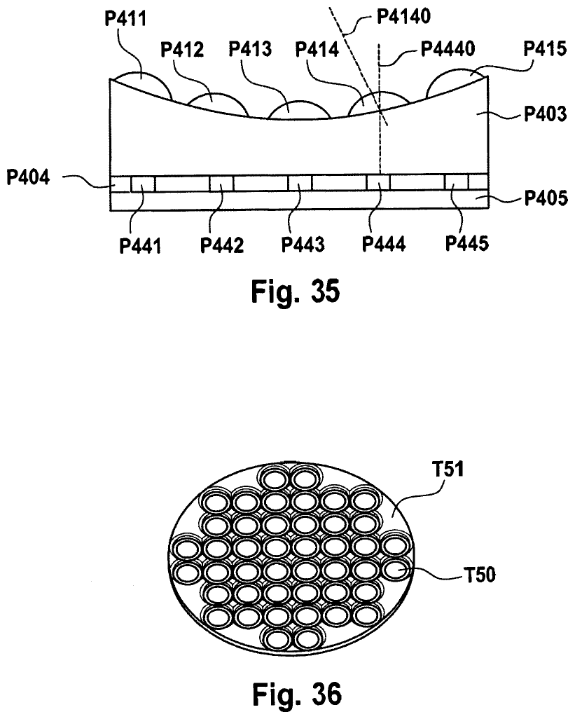

Another embodiment for the use of the method described in the following is the production of microlens arrays, for example microlens arrays for projection displays. A microlens array of this kind and its use in a projection display are shown in FIG. 35. Microlens arrays and projection displays are described in WO 2019/072324, DE 10 2009 024 894, DE 10 2011 076 083 and DE 10 2020 107 072, for example. The microlens array according to FIG. 35 is an integral, pressed glass part (pressed from a gob), which integrally combines the substrate or carrier P403 and the projection lenses P411, P412, P413, P414, P415. In addition, the projection lenses P411, P412, P413, P414, P415 having a concave contour or a parabolic contour are arranged one after the other. Owing to this arrangement, the optical axis P4140 of the projection lenses, such as the projection lens P414, is tilted relative to the orthogonal P4440 of the object structure P444 (see below), for example. A metal mask P404 is arranged on a side of the carrier P403 facing away from the projection lenses P411, P412, P413, P414, P415, wherein said mask comprises recesses, in which object structures P441, P442, P443, P444 and P445 are arranged. An illumination layer P405 is arranged over the object structures. It may also be provided that the illumination layer P405 comprises a transparent electrode, a light-emitting layer and a reflective back electrode. A light source as disclosed in U.S. Pat. No. 8,998,435 B2 also comes into consideration as an alternative illumination means.

The device 1 according to FIG. 1 for producing optical elements such as the headlight lens 202 comprises a melting unit 2, such as a trough, in which glass according to FIG. 15 is melted in a process step 120 according to FIG. 2A. FIG. 15 shows the result of a chemical analysis. The deviation of 0.07% of points out of 100% can be attributed to measurement inaccuracies and to impurities. The melting unit 2 may e.g. comprise an adjustable outlet 2B. In a process step 121, the liquid glass is brought from the melting unit 2 into a preform device 3 for producing a preform, such as a gob, for example having a mass of from 10 g to 400 g, for example a mass of from 50 g to 250 g, or a preform that is close to the final contours (a preform that is close to the final contours has a contour that is similar to the contour of the motor-vehicle headlight lens to be pressed or to the lens-like free-form for motor-vehicle headlights). This may e.g. comprise molds in which a defined quantity of glass is cast. The preform is produced in a process step 122 by means of the preform device 3.

The process step 122 is followed by a process step 123, in which the preform is transferred to the cooling apparatus 5 by means of a transfer station 4 and is cooled by means of the cooling apparatus 5 at a temperature of between 300° C. and 500° C., for example of between 350° C. and 450° C. In the present embodiment, the preform is cooled for over 10 minutes at a temperature of 400° C., such that its temperature in the interior is approximately 500° C. or greater, for example 600° C. or greater, for example T_{G} or greater.

In a subsequent process step 124, the preform is heated by means of the heating apparatus 6 at a temperature of no less than 725° C. and/or no greater than 1600° C., for example of between 1050° C. and 1300° C., wherein it is furthermore provided that the preform is heated such that the temperature of the surface of the preform after the heating is at least 100° C., for example at least 150° C., greater than T_{G} and is for example 775° C. to 925° C., for example 805° C. to 875° C. A combination of the cooling apparatus 5 with the heating apparatus 6 is an example of a temperature-control apparatus for setting the temperature gradient.

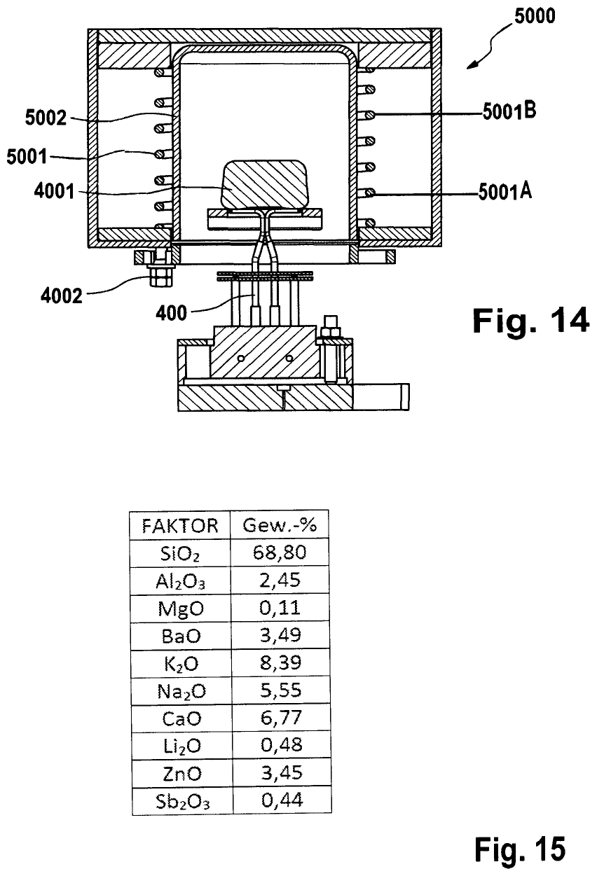

In one configuration, this temperature-control apparatus and/or the combination of the heating apparatuses 5 and 6 is designed as a hood-type annealing furnace 5000, as shown in FIG. 14. FIG. 14 shows a preform to be heated in the form of a gob 4001 on a support device 400 designed as a lance. Heating coils 5001 are provided for heating the gob 4001. In order to protect these heating coils 5001 against a defective gob bursting open, the interior of the hood-type annealing furnace 5000 is lined with a protective cover 5002.

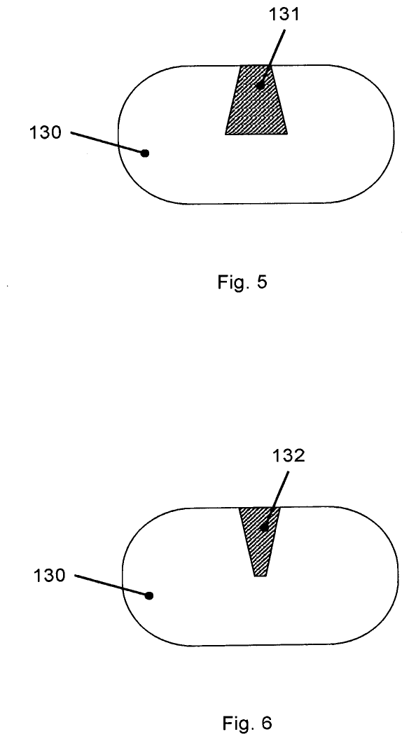

As explained below with reference to FIGS. 5 and 6, the process steps 123 and 124 are coordinated with one another such that a reversal of the temperature gradient is obtained. In this case, FIG. 5 shows an exemplary preform 130 before entering the cooling apparatus 5 and FIG. 6 shows the preform 130 with a reversed temperature gradient after leaving the heating apparatus 6. While the blank is hotter inside than outside before the process step 123 (with a continuous temperature curve), it is hotter outside than inside after the process step 124 (with a continuous temperature curve). The wedges denoted by reference signs 131 and 132 symbolize the temperature gradients here, wherein the width of a wedge 131 or 132 symbolizes a temperature.

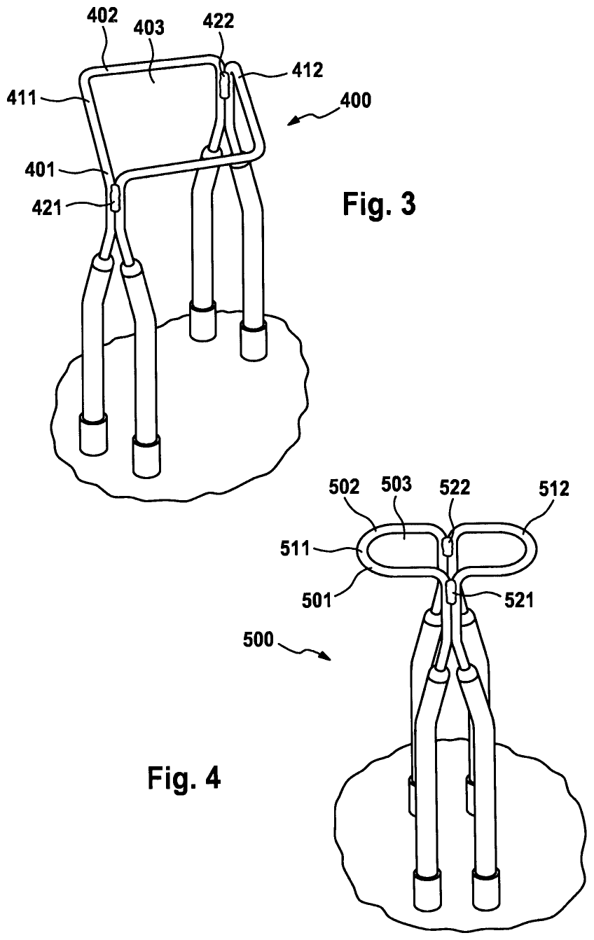

In order to reverse its temperature gradient, in another configuration, a preform resting on a cooled lance (not shown) is moved through the temperature-control device comprising the cooling apparatus 5 and the heating apparatus 6 (for example substantially continuously) or is held in one of the cooling apparatuses 5 and/or one of the heating apparatuses 6. A cooled lance is disclosed in DE 101 00 515 A1 and in DE 101 16 139 A1. Depending on the shape of the preform, FIGS. 3 and 4 show suitable lances, for example. Furthermore, coolant flows through the lance in accordance with the counterflow principle. Alternatively or additionally, it may be provided that the coolant is additionally and/or actively heated.

For the term “lance”, the term “support device” is also used in the following. The support device 400 shown in FIG. 3 comprises a carrier body 401 having a hollow cross section and an annular support surface 402. The carrier body 401 is tubular at least in the region of the support surface 402 and is uncoated at least in the region of the support surface 402. The diameter of the hollow cross section of the carrier body 401, at least in the region of the support surface 402, is no less than 0.5 mm and/or no greater than 1 mm. The external diameter of the carrier body 401, at least in the region of the support surface, is no less than 2 mm and/or no greater than 3 mm. The support surface 402 spans a square base surface 403 having rounded corners. The carrier body 401 comprises two flow channels 411 and 412 for the coolant flowing therethrough, which each only extend over a section of the annular support surface 402, wherein the flow channels 411 and 412 are connected in a region in which they leave the support surface 402 by means of metal filler material 421 and 422, for example solder.

The support device 500 shown in FIG. 4 comprises a carrier body 501 having a hollow cross section and an annular support surface 502. The carrier body 501 is tubular at least in the region of the support surface 502 and is uncoated at least in the region of the support surface 502. The diameter of the hollow cross section of the carrier body 501, at least in the region of the support surface 502, is no less than 0.5 mm and/or no greater than 1 mm. The external diameter of the carrier body 501, at least in the region of the support surface, is no less than 2 mm and/or no greater than 3 mm. The support surface 502 spans an oval base surface 503. The carrier body 501 comprises two flow channels 511 and 512 for the coolant flowing therethrough, which each only extend over a section of the annular support surface 502, wherein the flow channels 511 and 512 are connected in a region in which they leave the support surface 502 by means of metal filler material 521 and 522, for example solder.

It may be provided that, after passing through the cooling apparatus 5 (in the form of an annealing kiln), preforms are removed and are supplied by means of a transport apparatus 41, for example, to an intermediate storage unit (e.g. in which they are stored at room temperature). In addition, it may be provided that preforms are conducted to the transfer station 4 by means of a transport apparatus 42 and are phased into the continuing process by heating in the heating apparatus 6 (for example starting from room temperature).

In a departure from the method described with reference to FIG. 2A, in the method described with reference to FIG. 2B, the process step 121 is followed by the process step 122′, in which the cast gob is transferred to an annealing kiln 49 of the device 1A, as shown in FIG. 1A, by means of a transfer station 4. In this sense, an annealing kiln is for example a conveying apparatus, such as a conveyor belt, through which a gob is guided and is cooled in the process, for example with the addition of heat. The cooling is carried out to a certain temperature above room temperature or to room temperature, wherein the gob is cooled down to room temperature in the annealing kiln 49 or outside the annealing kiln 49. It is for example provided that a gob rests on a base made of graphite or a base containing graphite in the annealing kiln 49.

In the subsequent process step 123′ according to FIG. 2B, the gobs are supplied to a device 1B. The devices 1A and 1B may be in close proximity to one another, but may also be further away from one another. In the latter case, a transfer station 4A transfers the gobs from the annealing kiln 49 to a transport container BOX. The gobs are transported in the transport container BOX to the device 1B, in which a transfer station 4B removes the gobs from the transport container BOX and passes them to a hood-type annealing furnace 5000. The gobs are heated in the hood-type annealing furnace 5000 (process step 124′).

Flat gobs, wafers or wafer-like preforms can also be used to produce microlens arrays. Wafers of this kind may be square, polygonal or round, for example having a thickness of from 1 mm to 10 mm and/or a diameter of 4 inches to 5 inches.

The preform is blank-pressed, for example on both sides, to form an optical element, such as the headlight lens 202, in a process step 125 by means of the press 8. A suitable mold set is disclosed e.g. in EP 2 104 651 B1. Other particularly suitable pressing stations for pressing an optical element from a heated blank are disclosed in the German patent applications 10 2020 115 083.0 and 10 2020 115 078.4.

FIG. 16 shows a pressing station or mold set as an example for pressing an optical element from a heated blank, for example the headlight lens 202. The pressing station comprises an upper mold OF202 and a lower mold UF202, which in turn comprises a first partial mold UF2021 and a second partial mold UF2022 annularly surrounding the first partial mold UF2021. The first partial mold UF2021 and the second partial mold UF2022 are force-coupled to one another by means of springs UF2025 and UF2026. Here, pressing is carried out such that the distance between the first partial mold UF2021 and the upper mold OF202 is dependent on the volume of the preform, blank or gob.

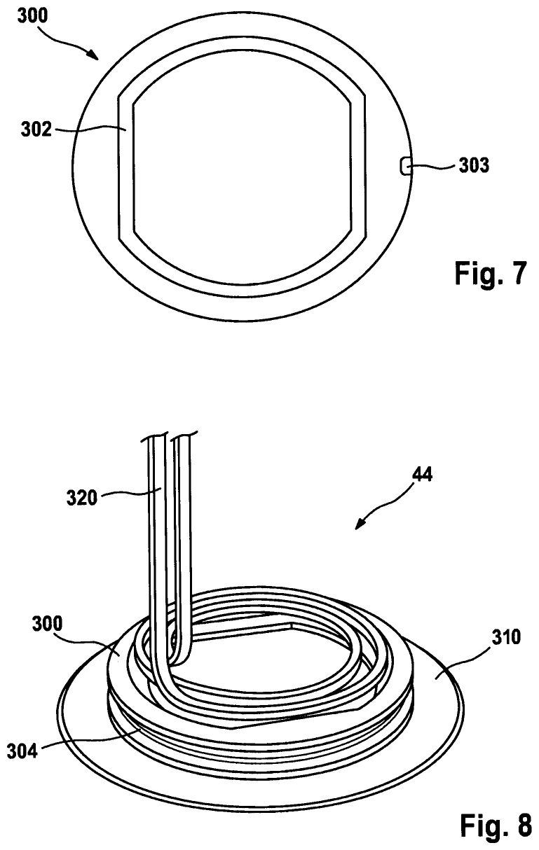

Following the pressing, the optical element (such as a headlight lens) is placed on a transport element 300 as shown in FIG. 7 by means of a transfer station 9. The annular transport element 300 shown in FIG. 7 consists of steel, for example of ferritic steel or martensitic steel. The annular transport element 300 comprises, on its inner face, a (corresponding) support surface 302, on which the optical element to be cooled, such as the headlight lens 202, is placed by its edge, such that the optical surfaces, such as the surface 205, are prevented from being damaged. Therefore, the (corresponding) support surface 302 and the support surface 261 of the lens edge 206 thus e.g. come into contact, as shown in FIG. 21, for example. Here, FIGS. 10 and 21 show the fixing and orientation of the headlight lens 202 on the transport element 300 by means of a limiting surface 305 or a limiting surface 306. The limiting surfaces 305 and 306 are orthogonal to the (corresponding) support surface 302, for example. In this case, it is provided that the limiting surfaces 305, 306 have enough play relative to the headlight lens 202, such that the headlight lens 202 can be placed on the transport element 300 for example without the headlight lens 202 becoming tilted or jammed on the transport element 300.

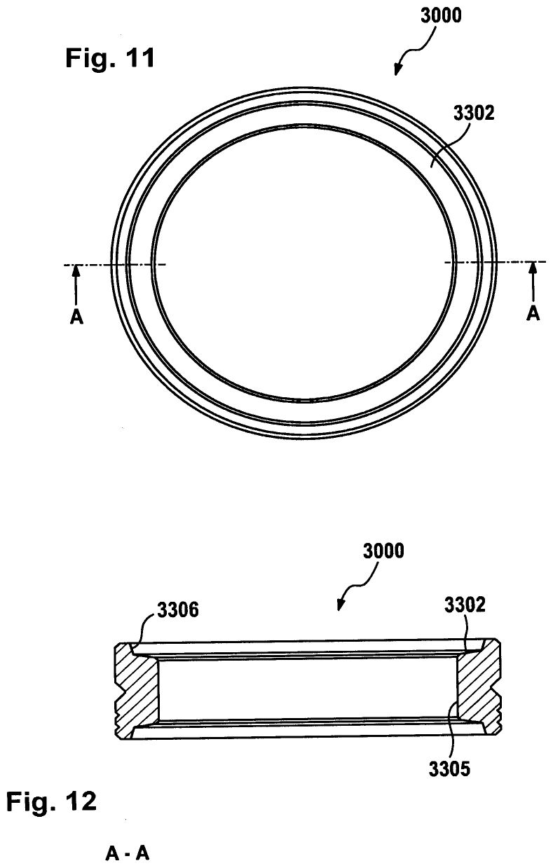

FIG. 11 shows a transport element 3000 which is designed in an alternative manner to the transport element 300 and is shown in FIG. 12 in a cross-sectional view. Unless described otherwise, the transport element 3000 is designed to be similar or identical/analogous to the transport element 300. The transport element 3000 (likewise) comprises limiting surfaces 3305 and 3306. In addition, a support surface 3302 is provided, which, however, in a modification to the support surface 302, is designed to slant towards the midpoint of the transport element 3000. It is for example provided that the limiting surfaces 3305 and 3306 have enough play relative to the headlight lens 202, wherein particularly precise orientation is achieved by the slope of the support surface 3302. Moreover, the transport element 3000 is handled in an analogous manner to the following description of the handling of the transport element 300. The angle of the slant or slope of the support surface 3302 relative to the orthogonal of the rotational axis or when used as intended relative to the support plane is between 5° and 20°, and in the embodiment shown is 10°.

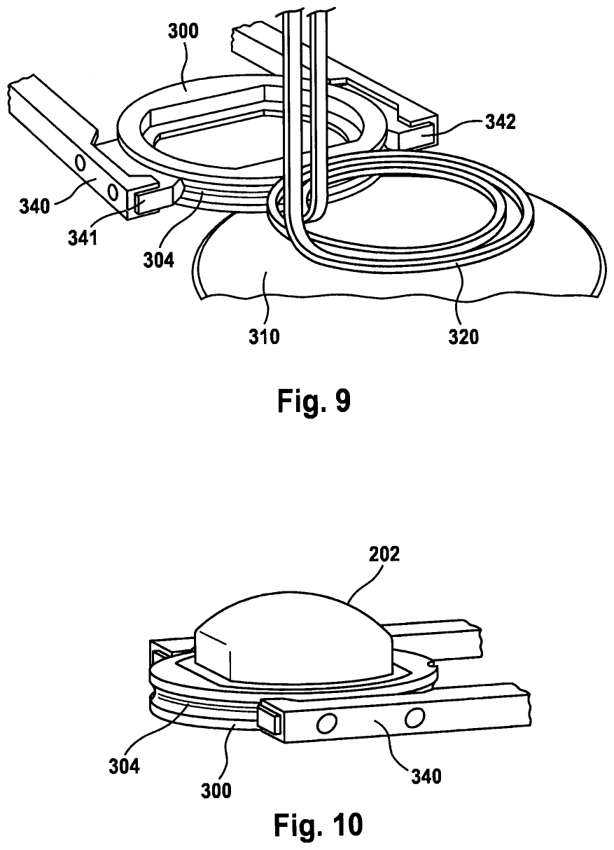

In addition, before placing the headlight lens 202 on the transport element 300, the transport element 300 is heated such that the temperature of the transport element 300 is approximately +−50 K the temperature of the headlight lens 202 or the edge 206. Furthermore, the heating is carried out in a heating station 44 by means of an induction coil 320, as shown in FIGS. 8 and 9. In these figures, the transport element 300 is placed on a support 310 and is then heated by means of the induction coil/induction heater 320 at a heating rate of 30-50 K/s, for example in less than 10 seconds. The transport element 300 is then grasped by a gripper 340, as shown in FIGS. 9 and 10. For this purpose, the transport element 300 also has an indentation 304 on its outer edge, which is designed to be circumferential in another configuration. For correct orientation, the transport element 300 comprises a marker slot 303. The transport element 300 is guided to the press 8 by means of the gripper 340 and, as shown in FIG. 10, the headlight lens 202 is transferred from the press 8 to the transport element 300 and placed thereon.

In a suitable configuration, it is provided that the support 310 is designed as a rotatable plate. The transport element 300 is thus placed on the support 310 designed as a rotatable plate by hydraulic and automated movement units (e.g. by means of the gripper 340). Centering is then carried out by two centering jaws 341 and 342 of the gripper 340 and specifically such that the transport elements are oriented in a defined manner by means of the marker slot 303, which is or can be detected by means of a position sensor. Once this transport element 300 has reached its linear end position, the support 340 designed as a rotatable plate begins to rotate until a position sensor has detected the marker slot 303.

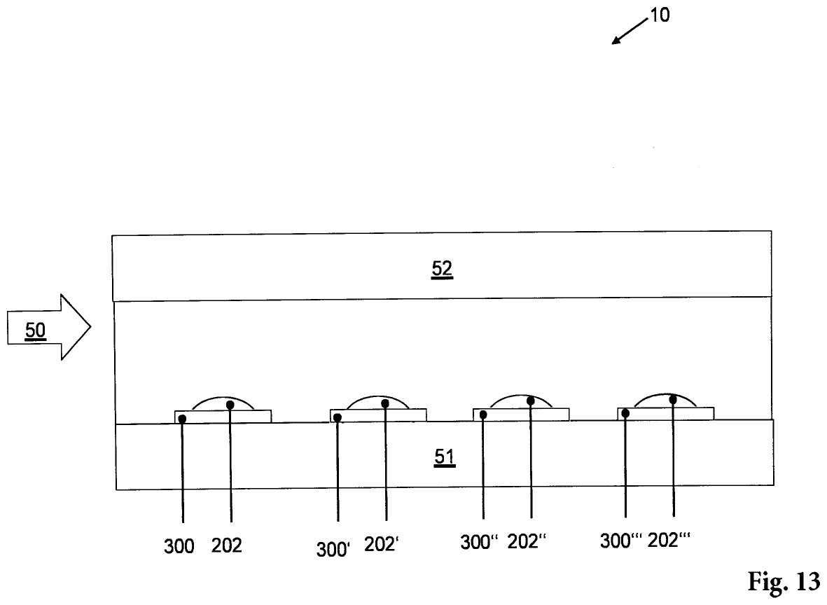

The transport element 300 together with the headlight lens 202 is then placed on the annealing kiln 10. In a process step 126, the headlight lens 202 is cooled by means of the annealing kiln 10. FIG. 13 is a detailed schematic view of the exemplary annealing kiln 10 from FIG. 1. The annealing kiln 10 comprises a tunnel which is or can be heated by means of a heating apparatus 52 and through which the headlight lenses 202, 202′, 202″, 202″′ are moved slowly on transport elements 300, 300′, 300″, 300″′ in the movement direction indicated by an arrow 50. In this process, the heating power decreases in the movement direction of the transport elements 300, 300′, 300″, 300′″ together with the headlight lenses 202, 202′, 202″, 202″′. For moving the transport elements 300, 300′, 300″, 300″′ together with the headlight lenses 202, 202′, 202″, 202′″, a conveyor belt 51 is e.g. provided, for example made up of chain members or implemented as a series of rollers.

At the end of the annealing kiln 10, a removal station 11 is provided, which removes the transport element 300 together with the headlight lens 202 from the annealing kiln 10. In addition, the removal station 11 separates the transport element 300 and the headlight lens 202 and transfers the transport element 300 to a return transport apparatus 43. From the return transport apparatus 43, the transport element 300 is transferred by means of the transfer station 9 to the heating station 44, in which the transport element 300 is placed on the support 310 designed as a rotatable plate and is heated by means of the induction heater 320.

It is then followed by a process step 127, in which quality control is carried out in a control station 46.

It may be provided that, with reference to the heating of a flat gob, microlens arrays are pressed, which are not used as an array, but instead their individual lenses are used. An array of this kind is for example shown in FIG. 36, which shows a large number of individual lenses T50 on an array T51, which have been generated by pressing. In such a case, it is provided that the individual lenses T50 of the array T51 are separated.

The device shown in FIG. 1 also comprises a control assembly 15 for controlling and/or regulating the device 1 shown in FIG. 1. The device 1A shown in FIG. 1A also comprises a control assembly 15A for controlling and/or regulating the device 1A shown in FIG. 1A. The device 1B shown in FIG. 1B also comprises a control assembly 15B for controlling and/or regulating the device 1B shown in FIG. 1B. The control assemblies 15, 15A and 15B ensure that the individual process steps are continuously interlinked.

In an optional process step, an optical element, such as the headlight lens 202, is moved through a surface-treatment station 45 on the transport element 300, as shown in FIG. 33 of the German patent application 10 2020 115 078.4 as an embodiment in a cross-sectional view. In this figure, the optically active surface 204 of the headlight lens 202 is sprayed with surface-treatment agent by means of a dual-substance nozzle 45o and at least one optically active surface of the optical element, such as the optically active surface 205 of the headlight lens 202, is sprayed with surface-treatment agent by means of a dual-substance nozzle 45u. The spraying process lasts no longer than 12 seconds, furthermore no longer than 8 seconds, furthermore no less than 2 seconds. The dual-substance nozzles 45o and 45u each comprise an inlet for atomizing air and an inlet for liquid, in which the surface-treatment agent is supplied, which is converted into a mist or spray mist by means of the atomizing air and exits through a nozzle. In order to control the dual-substance nozzles 45o and 45u, a control air port is also provided, which is actuated by means of a control assembly 15 or 15B described in the German patent application DE 10 2020 115 078 A1 (cf. FIGS. 1 and 1B of the German patent application DE 10 2020 115 078 A1).

In this disclosure, the terms “blank” and “preform” are used as synonyms.

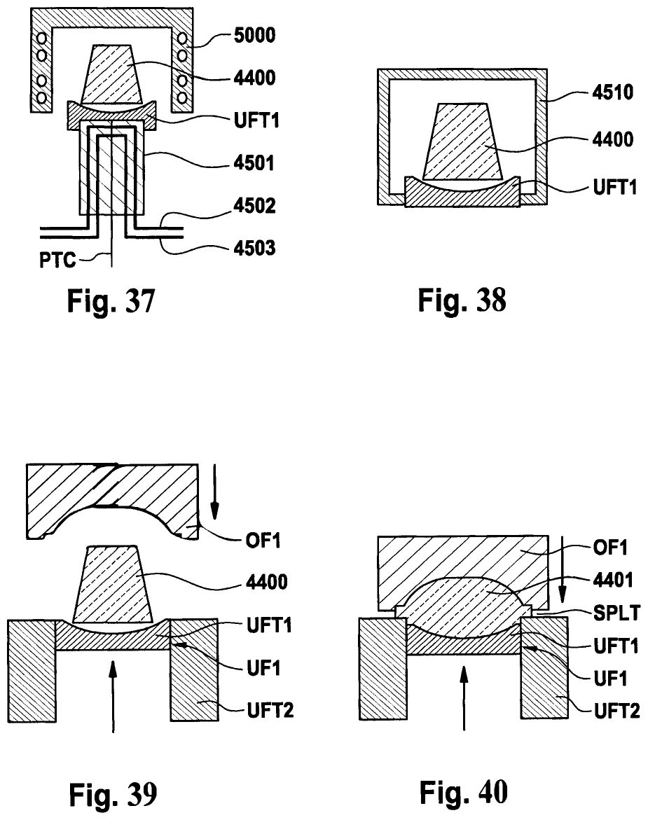

In an alternative or modification to the carrier bodies 401 and 501 according to FIGS. 3 and 4, FIG. 37 shows the support of a blank 4400 made of glass on a mold part, which is a lower mold part UFT1 in the present embodiment. For example, it is provided here that the underside of the blank 4400 has a radius of curvature that is greater than the radius of curvature of the concave shaped lower mold part UFT1. The blank 4400 resting on the lower mold part UFT1 can accordingly be heated in a first heating step by means of a hood-type annealing furnace 5000 described in FIG. 14. For details relating to the hood-type annealing furnace 5000 described in FIG. 37, reference is made to the description in relation to FIG. 14.

For cooling the lower mold part UFT1, a cooling block 4501 is provided, which can be cooled by at least one cooling channel 4502 or 4503 and therefore cools the lower mold part UFT1. At least one temperature sensor PTC is provided for regulating the cooling. In another configuration, a plurality of, but at least two, separate cooling channels 4502 and 4503 are provided, which can be adjusted separately from one another or in which the flows can be adjusted separately from one another. It is provided here, for example, that this separate adjustability serves to form a desired temperature distribution in the cooling block 4501 and/or therefore in the lower mold part UFT1. In the embodiment shown in FIG. 37, two separately adjustable cooling channels 4502 and 4503 are shown; however, more cooling channels which can be adjusted separately from one another may also be provided. The cooling channels 4502 and 4503 and optionally additional cooling channels being separate from one another relates (or may relate), inter alia, to the coolant, the coolant quantity, the coolant speed and/or the coolant temperature.

The process step for pressing the blank 4400 to form an optical element 4402, which for example corresponds to the optical element 202, can then be carried out. In this case, pressing can be carried out as described in relation to FIGS. 24, 25, 26, 27 and 28 of the German patent application DE 10 2020 115 078 A1. In addition or as a modification, a housing 4510 may be provided in which the heated blank 4400 is transported on the lower mold part UFT1 to the pressing. In this way, undesired cooling of the blank 4400 is reduced or prevented between the heating in the hood-type annealing furnace 5000 and the pressing unit or press 8.

In an alternative or modification to the pressing provided with reference to FIGS. 24, 25, 26, 27 and 28 of the German patent application DE 10 2020 115 078 A1, it may be provided that the lower mold UF or 822 is in (at least) two parts. In this case, the lower mold UF1 corresponding to the lower mold UF or 822 may comprise the lower mold part UFT1 and another lower mold part UFT2 surrounding the lower mold part UFT1, as shown in FIGS. 38 and 39. The press shown in FIG. 39 also comprises an upper mold OF1, which may correspond to the upper mold OF according to FIG. 24 of the German patent application DE 10 2020 115 078 A1 or to the upper mold 823 according to FIG. 25 of the German patent application DE 10 2020 115 078 A1.

In an alternative or modification to the method described with reference to FIGS. 24, 25, 26, 27 and 28 of the German patent application DE 10 2020 115 078 A1, it may be provided that, by means of the pressing, an intermediate formed body 4401 is first pressed from the blank 4400, rather than an optical element, as shown in FIG. 40. In this case, the upper mold OF1 and the lower mold UF1 are moved towards one another, but without the upper mold OF1 and the lower mold UF1 coming into contact or without the upper mold OF1 and the lower mold part UFT2 coming into contact. It can thus be seen in FIG. 40 that a gap SPLT is shown between the upper mold OF1 and the lower mold part UFT2, which gap is maintained. For example, it is thus provided that the gap SPLT or its gap height is at least 0.5 mm. In another configuration, it may be provided that the gap SPLT or its gap height is at least 2 mm. In another configuration, it may be provided that the gap SPLT or its gap height is at least 3 mm. For example, however, it is provided that the gap SPLT or its gap height is no greater than 10 mm.

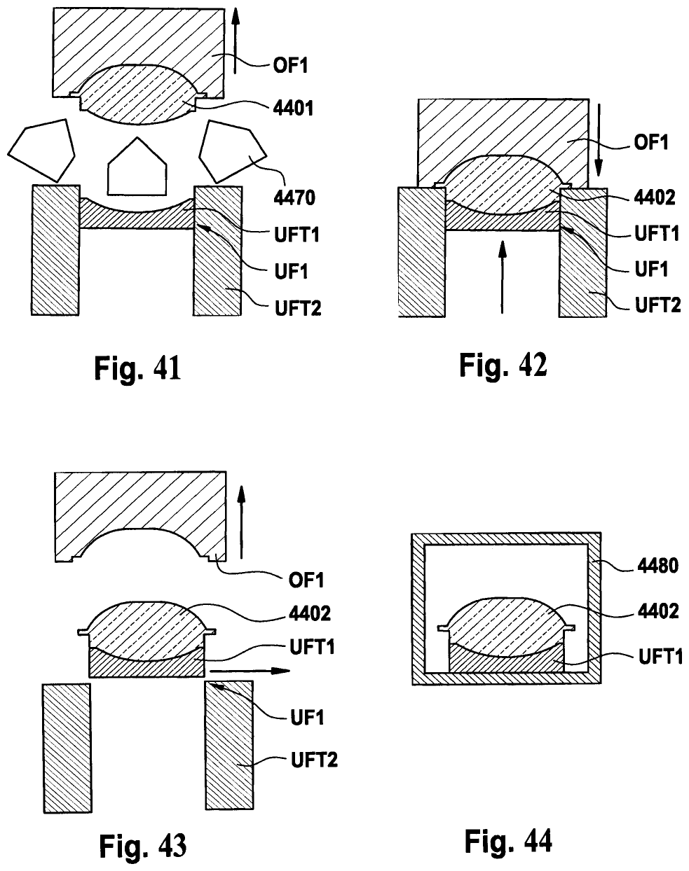

Following the process described with reference to FIG. 40, as described in FIG. 41, the upper mold OF1 and the lower mold UF1 are moved away from one another. In this process, the intermediate formed body 4401 is removed from the lower mold by negative pressure in a channel (not shown) of the upper mold OF1. It is then heated on the side facing the lower mold UF1 in a second heating step by means of a heating apparatus 4470. This heating may be carried out by a gas flame or by means of heating coils, for example.

Following the heating of the intermediate formed body 4401 by means of the heating apparatus 4470, the upper mold OF1 and the lower mold UF1 are moved towards one another again, as shown in FIG. 42. In this process, by contrast with the process step described in FIG. 40, the mold formed by the lower mold UF1 and the upper mold OF1 is closed. To do this, the upper mold OF1 and the lower mold part UFT2 are moved towards one another such that they come into contact and thus form a closed mold. By repressing by means of the lower mold part UFT1, the heated side or surface of the intermediate formed body 4401 is molded to form the optically active surface of the optical element 4402, for example. By means of the pressing step according to FIG. 42, the intermediate formed body 4401 is pressed to form the optical element 4402.

The pressing step described with reference to FIG. 42 is followed by a process step as described in FIG. 43 and in which the lower mold UF1 and the upper mold OF1 are moved away from one another. It may then be provided that the optical element 4402 is removed from the mold or the lower mold UF1 or the lower mold part UFT1 and is cooled analogously to the method described with reference to FIG. 7, 8, 9, 10, 11, 12 and/or 13. It may, however, also be provided that, in a modification to the method described with reference to FIG. 7, 8, 9, 10, 11, 12 and/or 13, the optical element 4402 is modified, as described in FIG. 44. In this case, the optical element 4402 is not removed from the lower mold part UFT1 and is not placed on a transport element such as the transport element 300 either, but instead is removed from the press 8 together with the lower mold part UFT1. The optical element 4402 on the lower mold part UFT1 then passes through an annealing kiln 4480 corresponding to the annealing kiln 10, in which the optical component 4402 is cooled in accordance with a cooling regime.

It may also be provided that the optical element 4402 is also exposed to surface-treatment agents or sprayed with a surface-treatment agent, as described with reference to FIG. 33 of the German patent application DE 10 2020 115 078 A1. In this process, in a modification to the surface-treatment station 45 according to FIG. 33 of the German patent application DE 10 2020 115 078 A1, it is provided that only the surface of the optical element 4402 facing away from the lower mold part UFT1 is sprayed with surface-treatment agent or exposed to at least one spray mist by means of a dual-substance nozzle 45o. This process is carried out with reference to the method described in FIG. 33.

The methods described with reference to FIG. 37, 38, 39, 40, 41, 42, 43 and/or 44 may be integrated in the process sequence described with reference to FIGS. 1 to 33 of the German patent application DE 10 2020 115 078 A1 individually, in groups or in multiples. The heating process described with reference to FIG. 5 can thus be replaced or modified using a cooling body 4450, for example. In addition, the approach described with reference to FIG. 14 for heating a preform can be followed by the approach according to FIG. 40. It may also be provided that the pressing of the optical element 202, as described with reference to FIG. 24, 25, 26, 27, 28, 29, 30, 31 and/or 32 of the German patent application DE 10 2020 115 078 A1, is replaced by the pressing of an intermediate formed body 4401, i.e. two-stage pressing, as described with reference to FIGS. 40, 41 and 42. In this case, in a modification to the method described with reference to FIG. 25 of the German patent application DE 10 2020 115 078 A1, the heating apparatus 872 according to the German patent application DE 10 2020 115 078 A1 may, inter alia, be used instead of the heating apparatus 4470.

It may be provided that the heating apparatus 4470 assumes a double function for implementing the second heating step. This is carried out, for example, in connection with the second heating step or during the second heating step, when the lower mold part UFT1 remains in the press. Therefore, for example, the heating apparatus 4470 for implementing the second heating step can be provided both for heating the underside of the intermediate formed body 4401 and for heating the lower mold part UFT1 (and optionally also the lower mold part UFT2) before receiving a blank 4400. When implementing the method according to FIGS. 37, 38, 39 and 40, i.e. the pressing of an intermediate formed body 4401, the heating device 872 is or can be used to implement the heating apparatus 4470, for example (e.g. as an induction heater or radiant heater, for example).

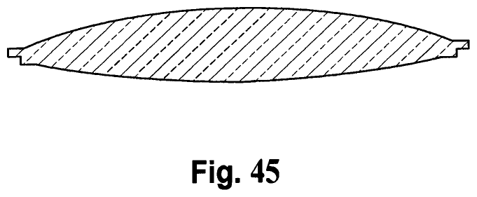

The method described, for example the method described with reference to the modification or partial modification according to FIG. 37, 38, 39, 40, 41, 42, 43 and/or 44, is for example suitable for being used for or having the effect of pressing biconvex lenses. The method is, for example, particularly suitable for pressing biconvex lenses, as disclosed in FIG. 45 as an embodiment or as disclosed in WO 2007/03110 A1.

The elements in FIG. 1, 1A, 1B, 5, 6, 13, 16, 17, 21, 22, 25, 26, 27, 28, 29, 30, 35, 36, 37, 38, 39, 40, 41, 42, 43, 44 and 45 are not necessarily shown to scale for the sake of simplicity and clarity.

Therefore, for example, the scales of some elements are exaggerated compared with other elements in order to improve the understanding of the embodiments of the present disclosure.

By means of the proposed method for producing an optical element or a headlight lens, weather resistance and/or hydrolytic resistance comparable to that of borosilicate glass is obtained. Furthermore, the costs of the production process are only slightly higher than those of the production process for optical elements or headlight lenses having weather resistance and/or hydrolytic resistance corresponding to soda-lime glass. The claimed or disclosed method makes it possible to extend the scope of application of blank-pressed lenses, for example in relation to objective lenses, projection displays, microlens arrays and/or vehicle headlights, for example adaptive vehicle headlights. The disclosure makes it possible to provide an improved production method for optical elements. In this case, both (particularly) high contour accuracy and a (particularly) high surface quality are achieved for optical elements or lenses or headlight lens. In addition, it is possible to reduce the costs of a production process for objective lenses and/or headlights, microprojectors or vehicle headlights. The disclosure makes it possible to achieve a particularly good compromise between the blank-pressing ability of optical elements and their chemical resistance.

Alternatively or additionally, an increase in the aluminum concentration in the region close to the surface can also be provided, as disclosed in U.S. Pat. No. 7,798,688 B2 (incorporated by reference in its entirety).

1. Vehicle headlight lens made of glass having a composition comprising
65 wt. % to 75 wt. % SiO₂,
1.5 wt. % to 3 wt. % Al₂O₃,
3 wt. % to 4 wt. % BaO,
3 wt. % to 10 wt. % K₂O,
3 wt. % to 10 wt. % Na₂O,
3 wt. % to 10 wt. % CaO,
2 wt. % to 4 wt. % ZnO,
0 wt. % B₂O₃,
wherein the sum of the alkalis in the glass is no less than 10 wt. % and no greater than 18 wt. %;
wherein the refractive index of the glass is no less than 1.5; and
wherein the HGB value of the glass is no greater than 0.3.

2. Vehicle headlight lens according to claim 1, wherein the refractive index of the glass is no less than 1.52.

3. Vehicle headlight lens according to claim 1, wherein the refractive index of the glass is no greater than 1.54.

4. Vehicle headlight lens according to claim 1, wherein the temperature of the glass corresponding to the viscosity 2 dPas is less than 1600° C.

5. Vehicle headlight lens according to claim 1, wherein the composition contains 0.1 wt. % to 5 wt. % MgO.

6. Vehicle headlight lens according to claim 1, wherein the composition contains 0 wt. % PbO.

7. Vehicle headlight lens according to claim 1, wherein the vehicle headlight lens comprises at least one blank-pressed, optically active surface.

8. Vehicle headlight lens according to claim 1, wherein the vehicle headlight lens comprises at least one convex, blank-pressed, optically active surface.

9. Vehicle headlight lens according to claim 8, wherein the vehicle headlight lens comprises at least one planar, blank-pressed, optically active surface.

10. Vehicle headlight lens according to claim 1, wherein the vehicle headlight lens comprises a first convex, blank-pressed, optically active surface and at least one second convex, blank-pressed, optically active surface.

11. Optical element made of glass having a composition containing
65 wt. % to 75 wt. % SiO₂,
1.5 wt. % to 3 wt. % Al₂O₃,
3 wt. % to 4 wt. % BaO,
3 wt. % to 10 wt. % K₂O,
3 wt. % to 10 wt. % Na₂O,
3 wt. % to 10 wt. % CaO,
0.1 wt. % to 5 wt. % MgO,
3 wt. % to 3.75 wt. % ZnO,
0.3 wt. % to 1.3 wt. % Sb₂O₃;
wherein the sum of the alkalis in the glass is no less than 10 wt. % and no greater than 18 wt. %.

12. Optical element according to claim 11, wherein the HGB value of the glass is no greater than 0.3.

13. Optical element according to claim 12, wherein the temperature of the glass corresponding to the viscosity 2 dPas is less than 1600° C.

14. Optical element according to claim 13, wherein the composition contains no less than 2.25 wt. % Al₂O₃.

15. Optical element according to claim 14, wherein the composition does not contain any B₂O₃.

16. Optical element according to claim 15, wherein the refractive index of the glass is no less than 1.5.

17. Optical element according to claim 15, wherein the composition contains 0 wt. % PbO.

18. Optical element according to claim 15, wherein the sum of the alkalis in the glass is no less than 11 wt. % and no greater than 16 wt. %.

19. Optical element according to claim 18, wherein the sum of the alkalis in the glass is no less than 12 wt. %.

20. Optical element according to claim 19, wherein the composition contains 0.1 wt. % to 5 wt. % MgO.

21. Optical element according to claim 20, wherein the composition contains 0.2 wt. % to 1 wt. % Li₂O.

22. Optical element according to claim 21, wherein the refractive index of the glass is no less than 1.52.

23. Optical element according to claim 22, wherein the refractive index of the glass is no greater than 1.54.

24. Vehicle headlight comprising
a light source,
primary optics for generating an illumination pattern by means of light emitted by the light source,
secondary optics for imaging the illumination pattern, the secondary optics comprising at least one lens made of glass having a composition containing
65 wt. % to 75 wt. % SiO₂,
1.5 wt. % to 3 wt. % Al₂O₃,
3 wt. % to 4 wt. % BaO,
3 wt. % to 10 wt. % K₂O,
3 wt. % to 10 wt. % Na₂O,
3 wt. % to 10 wt. % CaO,
2 wt. % to 4 wt. % ZnO,
wherein the sum of the alkalis in the glass is no less than 10 wt. % and no greater than 18 wt. %,
wherein the refractive index of the glass is no less than 1.5, and
wherein the HGB value of the glass is no greater than 0.3.

25. Vehicle headlight according to claim 24, wherein the composition contains no less than 2.25 wt. % Al₂O₃.

26. Vehicle headlight according to claim 25, wherein the composition does not contain any B₂O₃, and wherein the temperature of the glass corresponding to the viscosity 2 dPas is less than 1600° C.

27. Vehicle headlight according to claim 26, wherein the composition contains
0.1 wt. % to 5 wt. % MgO,
0.2 wt. % to 1 wt. % Li₂O,
0 wt. % PbO.

28. Vehicle headlight according to claim 24, wherein the composition does not contain any B₂O₃, and wherein the temperature of the glass corresponding to the viscosity 2 dPas is less than 1600° C.
